(19) United States
(12) Patent Application Publication
(10) Pub. No.: US 2025/0357792 A1
(43) Pub. Date: Nov. 20, 2025

(54) ASYMMETRIC SPIRAL ANTENNAS WITH PARASITIC ELEMENTS FOR WIRELESS POWER TRANSMISSION

(71) Applicant: ENERGOUS CORPORATION, San Jose, CA (US)

(72) Inventors: Alister HOSS, Long Beach, CA (US); Evangelos KORNAROS, Santa Cruz, CA (US)

(21) Appl. No.: 19/288,776

(22) Filed: Aug. 1, 2025

Related U.S. Application Data
(63) Continuation of application No. 17/700,337, filed on Mar. 21, 2022, now Pat. No. 12,431,735.

(51) Int. Cl. H02J 50/10; H02J 50/00; H02J 50/20; H02J 50/40; H02J 50/80

(52) U.S. Cl. CPC H02J 50/10; H02J 50/001; H02J 50/20; H02J 50/402; H02J 50/80

(57) ABSTRACT

A near-field charging system for wirelessly charging electronic devices using electromagnetic energy having a low frequency is provided. The near-field charging system comprises: (A) a transmitting antenna comprising: a first substrate; and a first antenna, coupled to the first substrate, that follows a first meandering pattern having a first length, wherein the transmitting antenna has a first port impedance, and (B) a receiving antenna comprising: a second substrate; and a second antenna, coupled to the second substrate, that follows a second meandering pattern having a second length, wherein: (i) the second length is less than the first length, and (ii) the receiving antenna has a second port impedance that is less than the first port impedance. The transmitting antenna is configured to transmit electromagnetic energy having a frequency at or below 60 MHz to the receiving antenna at an efficiency above 90%.

### CROSS-REFERENCE TO RELATED APPLICATIONS

This application is a continuation of U.S. patent application Ser. No. 17/700,337, filed on Mar. 21, 2022, entitled “Asymmetric Spiral Antennas With Parasitic Elements For Wireless Power Transmission,” which is a continuation of PCT Application No. PCT/US20/51695, filed Sep. 19, 2020, entitled “Asymmetric Spiral Antennas With Parasitic Elements For Wireless Power Transmission,” which claims priority to U.S. Provisional Application Ser. No. 62/903,680, filed Sep. 20, 2019, entitled “Asymmetric Spiral Antennas With Parasitic Element For Wireless Power Transmission,” and to U.S. Provisional Application Ser. No. 62/907,244, filed Sep. 27, 2019, entitled “Asymmetric Spiral Antennas With Parasitic Elements For Wireless Power Transmission.” Each of these related applications is fully incorporated herein by reference in its respective entirety.

### TECHNICAL FIELD

The present disclosure relates generally to wireless power transmission, and more particularly to spiral antennas used for near-field power transmission and reception.

### BACKGROUND

Portable electronic devices such as smartphones, tablets, notebooks and other electronic devices have become a necessity for communicating and interacting with others. The frequent use of portable electronic devices, however, uses a significant amount of power, which quickly depletes the batteries attached to these devices. Inductive charging pads and corresponding inductive coils in portable devices allow users to wirelessly charge a device by placing the device at a particular position on an inductive pad to allow for a contact-based charging of the device due to magnetic coupling between respective coils in the inductive pad and in the device.

Conventional inductive charging pads, however, suffer from many drawbacks. For one, users typically must place their devices at a specific position and in a certain orientation on the charging pad because gaps (“dead zones” or “cold zones”) exist on the surface of the charging pad. In other words, for optimal charging, the coil in the charging pad needs to be aligned with the coil in the device in order for the required magnetic coupling to occur. Additionally, placement of other metallic objects near an inductive charging pad may interfere with operation of the inductive charging pad. Thus, even if the user places their device at the exact right position, if another metal object is also on the pad, then magnetic coupling still may not occur and the device will not be charged by the inductive charging pad. This results in a frustrating experience for many users as they may be unable to properly charge their devices. Also, inductive charging requires a relatively large receiver coil to be placed within a device to be charged, which is less than ideal for devices where internal space is at a premium.

Charging using electromagnetic radiation (e.g., microwave radiation waves) offers promise. In these systems, however, problems arising from misalignment still persist (e.g., misalignment between the receiving antenna and the transmitting antenna, in some instances, can result in an efficiency of the system dropping significantly). Moreover, these systems could benefit from transmitting and receiving antenna designs that do not require matching port impedances to function at a high efficiency.

### SUMMARY

Accordingly, there is a need for wireless charging systems that address the problems identified above. To this end, transmitting and receiving antennas are described herein that (i) mitigate problems arising from the misalignment of the receiving antenna and the transmitting antenna (e.g., when wireless charging using electromagnetic radiation at a near-field distance) and (ii) have mismatched port impedances but can nevertheless operate at a high efficiency (e.g., efficiency greater than 90%).
(A1) In accordance with some embodiments, a near-field charging system for wirelessly charging electronic devices using electromagnetic energy having a low frequency (e.g., at or below 60 MHz) is provided. The near-filed charging system includes a transmitting antenna comprising: (i) a first substrate, and (ii) a first antenna, coupled to the first substrate, that follows a first meandering pattern having a first length, wherein the transmitting antenna has a first port impedance. The near-filed charging system also includes a receiving antenna comprising: (i) a second substrate, and (ii) a second antenna, coupled to the second substrate, that follows a second meandering pattern having a second length, whereby: (a) the second length is less than the first length, and (b) the receiving antenna has a second port impedance that is less than the first port impedance. Moreover, the transmitting antenna is configured to transmit electromagnetic energy having a low frequency at or below 60 MHz to the receiving antenna at an efficiency above 90%. Furthermore, the receiving antenna is coupled to power-conversion circuitry for converting the electromagnetic energy into usable power for charging or powering an electronic device that is coupled to the receiving antenna and the power-conversion circuitry.
(A2) In some embodiments of A1, the first meandering pattern is a first spiral pattern with a first number of revolutions, and the second meandering pattern is a second spiral pattern with a second number of revolutions. The second number of revolutions is less than the first number of revolutions.
(A3) In some embodiments of A2, the first spiral pattern is a planar rectangular spiral, and the second spiral pattern is a planar rectangular spiral. In other embodiments, the first spiral pattern is a planar circular spiral, and the second spiral pattern is a planar circular spiral (or some other spiral shape).
(A4) In some embodiments of any of A1-A3, the transmitting antenna further comprises a first via configured to feed radio frequency (RF) signals to the first antenna. Moreover, the receiving antenna further comprises a second via configured to transfer energy harvested by the second antenna to the power-conversion circuitry.
(A5) In some embodiments of A4, the first via is positioned at a center of the first substrate while the second via is offset in at least one direction from a center of the second substrate.
(A6) In some embodiments of any of A1-A5, the first substrate has a first thickness, and the second substrate has a second thickness that is less than the first thickness.
(A7) In some embodiments of any of A1-A6, the first antenna has a first width, and the second antenna has a second width that is greater than the first width.
(A8) In some embodiments of A7, the first antenna comprises a first plurality of antenna elements, and at least one antenna element of the first plurality of antenna elements has a third width that is less than the first width.
(A9) In some embodiments of A8, the second antenna comprises a second plurality of antenna elements, and at least one antenna element of the second plurality of antenna elements has a fourth width that is less than the second width and greater than the third width.
(A10) In some embodiments of any of A1-A9, the transmitting antenna is configured to transmit electromagnetic energy having a frequency between 30 MHz and 50 MHz.
(A11) In some embodiments of A10, the transmitting antenna is configured to transmit electromagnetic energy having a frequency at 40 MHz.
(A12) In some embodiments of any of A1-A11, the second substrate includes opposing first and second surfaces, whereby the second antenna is coupled to the first surface, and the receiving antenna further comprises a parasitic element, coupled to the second surface of the second substrate, shaped to reduce the receiving antenna's sensitivity to misalignment with the transmitting antenna. Put another way, the parasitic antenna is adapted to, according to a design of the parasitic antenna (i.e., a shape of the parasitic antenna), disrupt energy field distributions around the receiving antenna.
(A13) In some embodiments of A12, the receiving antenna is configured to: (i) harvest electromagnetic energy having a frequency at or below 60 MHz at an efficiency above 90% when aligned center-to-center with the transmitting antenna, and (ii) harvest electromagnetic energy having a frequency at or below 60 MHz at an efficiency above 85% when misaligned center-to-center with the corresponding transmitting antenna by approximately 5 mm.
(A14) In some embodiments of any of A12-A13, the parasitic element includes a layer of copper.
(A15) In some embodiments of any of A12-A14, the layer of copper is rectangular or circular shaped.
(B1) In another aspect, a near-field charging system for wirelessly charging electronic devices using electromagnetic energy having a low frequency is provided. The near-field charging system includes: (i) a transmitting antenna having a first antenna that follows a first meandering pattern, and (ii) a receiving antenna having a second antenna that follows a second meandering pattern, whereby the second meandering pattern is different from the first meandering pattern. Furthermore, the transmitting antenna is configured to transmit electromagnetic energy having a frequency at or below 60 MHz to the receiving antenna at an efficiency above 90% and, moreover, the receiving antenna is coupled to power-conversion circuitry for converting the electromagnetic energy into usable power for charging or powering an electronic device that is coupled to the receiving antenna and the power-conversion circuitry.
(B2) The near-field charging system includes the structural characteristics for the near-field charging system described above in any of A2-A15.
(C1) In yet another aspect, a near-field charging system for wirelessly charging electronic devices using electromagnetic energy having a low frequency is provided. The near-field charging system includes a pair of asymmetric antennas, including: (i) a transmitting antenna and (ii) a receiving antenna. Furthermore, the transmitting antenna is configured to transmit electromagnetic energy having a frequency at or below 60 MHz to the receiving antenna at an efficiency above 90% and, moreover, the receiving antenna is coupled to power-conversion circuitry for converting the electromagnetic energy into usable power for charging or powering an electronic device that is coupled to the receiving antenna and the power-conversion circuitry.
(C2) In some embodiments of C1, an antenna of the transmitting antenna follows a first spiral pattern with a first number of revolutions, and an antenna of the receiving antenna follows a second spiral pattern with a second number of revolutions, the second number of revolutions being less than the first number of revolutions.
(C3) In some embodiments of any of C1-C2, the transmitting antenna includes a first via and the receiving antenna includes a second via. Moreover, when the transmitting antenna is aligned with the receiving antenna, the first via and the second via are axially misaligned.
(C4) In some embodiments of any of C1-C3, the pair of asymmetric antennas terminate with different port impedances.
(C5) In some embodiments of any of C1-C4, the transmitting antenna has a port impedance of approximately 50 ohms, and the receiving antenna has a port impedance of approximately 5 ohms.
(C6) The near-field charging system includes the structural characteristics for the near-field charging system described above in any of A2-A15.
(D1) In another aspect, a wireless power receiver for wirelessly charging electronic devices using electromagnetic energy having a low frequency is provided. The wireless power receiver includes a receiving antenna comprising an antenna, coupled to a substrate, that follows a meandering pattern having a length, whereby: (i) the length of the antenna is less than a length of an antenna of a paired transmitting antenna, and (ii) the receiving antenna has a port impedance that is less than a port impedance of the paired transmitting antenna. Furthermore, the transmitting antenna is configured to transmit electromagnetic energy having a frequency at or below 60 MHz to the receiving antenna at an efficiency above 90% and, moreover, the receiving antenna is coupled to power-conversion circuitry for converting the electromagnetic energy into usable power for powering an electronic device that is coupled to the power-conversion circuitry.
(D2) The wireless power receiver includes the structural characteristics for the receiving antenna described above in any of A1-A15.
(E1) In another aspect, a wireless power transmitter for wirelessly charging electronic devices using electromagnetic energy having a low frequency is provided. The wireless power transmitter includes a transmitting antenna comprising an antenna, coupled to a substrate, that follows a meandering pattern having a length, whereby: (i) the length of the antenna is greater than a length of an antenna of a paired receiving antenna, and (ii) the paired receiving antenna has a port impedance that is less than a port impedance of the transmitting antenna. Furthermore, the transmitting antenna is configured to transmit electromagnetic energy having a frequency at or below 60 MHz to the receiving antenna at an efficiency above 90% and, moreover, the receiving antenna is coupled to power-conversion circuitry for converting the electromagnetic energy into usable power for powering an electronic device that is coupled to the power-conversion circuitry.
(E2) The wireless power transmitter includes the structural characteristics for the transmitting antenna described above in any of A1-A15.
(F1) In yet another aspect, a receiving antenna for wirelessly charging electronic devices using electromagnetic energy is provided. The receiving antenna includes: (i) a circuit board, forming a bottom surface of the receiving antenna, that includes power-conversion circuitry, (ii) a ground plane, positioned on top of and electrically isolated from the circuit board, that defines a first opening, (iii) a parasitic element, positioned on top of and electrically isolated from the ground plane, that defines a second opening, and (iv) an antenna element, positioned on top of and electrically isolated from the parasitic element, that follows a spiral pattern, the antenna element forming a top surface of the receiving antenna. Moreover, the parasitic antenna is shaped to reduce the receiving antenna's sensitivity to misalignment with a corresponding transmitting antenna.

Put another way, the parasitic antenna is adapted to, according to a design of the parasitic antenna (i.e., a shape of the parasitic antenna), disrupt energy field distributions around the receiving antenna (e.g., to reduce the receiving antenna's sensitivity to misalignment with a corresponding transmitting antenna). In doing so, the parasitic antenna imparts a degree of movability/mobility to the receiving antenna (or more generally to the near-field charging system), meaning that the receiving antenna and the corresponding transmitting antenna can transfer energy, wirelessly, with a high degree of efficiency (e.g., greater than 80%) even when the receiving antenna and the corresponding transmitting antenna are not perfectly aligned center-to-center (e.g., the receiving antenna and the corresponding transmitting antenna can transfer energy wirelessly with a high degree of efficiency with a center-to-center misalignment of, e.g., one inch).
(F2) In some embodiments of F1, the first and second openings are concentric. Furthermore, in some embodiments, the circuit board also includes an opening, which is concentric with the first and second openings.
(F3) In some embodiments of any of F1-F2, (i) the receiving antenna is configured to harvest electromagnetic energy having a frequency at or below 60 MHz at an efficiency above 90% when aligned center-to-center with the corresponding transmitting antenna, and (ii) the receiving antenna is configured to harvest electromagnetic energy having a frequency at or below 60 MHz at an efficiency above 85% when misaligned center-to-center with the corresponding transmitting antenna by approximately 5 mm.
(F4) In some embodiments of any of F1-F3, the parasitic element includes a layer of copper.
(F5) In some embodiments of F4, the layer of copper is rectangular or circular shaped.
(F6) In some embodiments of any of F1-F5, the circuit board, ground plane, parasitic element, and antenna element are assembled in a stack.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

So that the present disclosure can be understood in greater detail, a more particular description may be had by reference to the features of various embodiments, some of which are illustrated in the appended drawings. The appended drawings, however, merely illustrate pertinent features of the present disclosure and are therefore not to be considered limiting, for the description may admit to other effective features.

FIG. 1A is a block diagram illustrating a representative wireless power transmission system in accordance with some embodiments.

FIG. 1B is another block diagram of an RF wireless power transmission system, in accordance with some embodiments.

FIG. 1C is a block diagram showing components of an example RF charging pad that includes an RF power transmitter integrated circuit and antenna zones, in accordance with some embodiments.

FIG. 1D is a block diagram showing components of an example RF charging pad that includes an RF power transmitter integrated circuit coupled to a switch, in accordance with some embodiments.

FIGS. 2A and 2B shows various views of an example transmitting antenna in accordance with some embodiments.

FIGS. 3A to 3C shows various views of an example receiving antenna in accordance with some embodiments.

FIG. 4A shows a side view of an example transmitting antenna in accordance with some embodiments.

FIG. 4B shows a side view of an example receiving antenna in accordance with some embodiments.

FIG. 5 shows one example of an electronic device, with a receiving antenna integrated therein, positioned on a transmitted pad, having a transmitting antenna integrated therein.

FIG. 6 is a block diagram illustrating an interaction between a transmitting antenna and a receiving antenna in accordance with some embodiments.

FIGS. 7A and 7B show energy transfer efficiencies of a receiving antenna and transmitting antenna.

FIG. 8A shows a side view of an example receiving antenna having a parasitic element in accordance with some embodiments.

FIGS. 8B-1 to 8B-4 show the individual components of an example receiving antenna having a parasitic element in accordance with some embodiments.

FIGS. 8C-1 to 8C-3 show various example parasitic elements in accordance with some embodiments.

FIG. 9A shows energy transfer efficiencies of an example receiving antenna lacking a parasitic element.

FIG. 9B shows energy transfer efficiencies of an example receiving antenna with a parasitic element.

FIG. 10A shows energy transfer efficiencies of an example receiving antenna lacking a parasitic element misaligned with a transmitting antenna.

FIG. 10B shows energy transfer efficiencies of an example receiving antenna with a parasitic element misaligned with a transmitting antenna.

FIG. 11A shows an example receiving antenna aligned center-to-center with an example transmitting antenna.

FIG. 11B shows an example receiving antenna misaligned with an example transmitting antenna.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Numerous details are described herein in order to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not been described in exhaustive detail so as not to unnecessarily obscure pertinent aspects of the embodiments described herein.

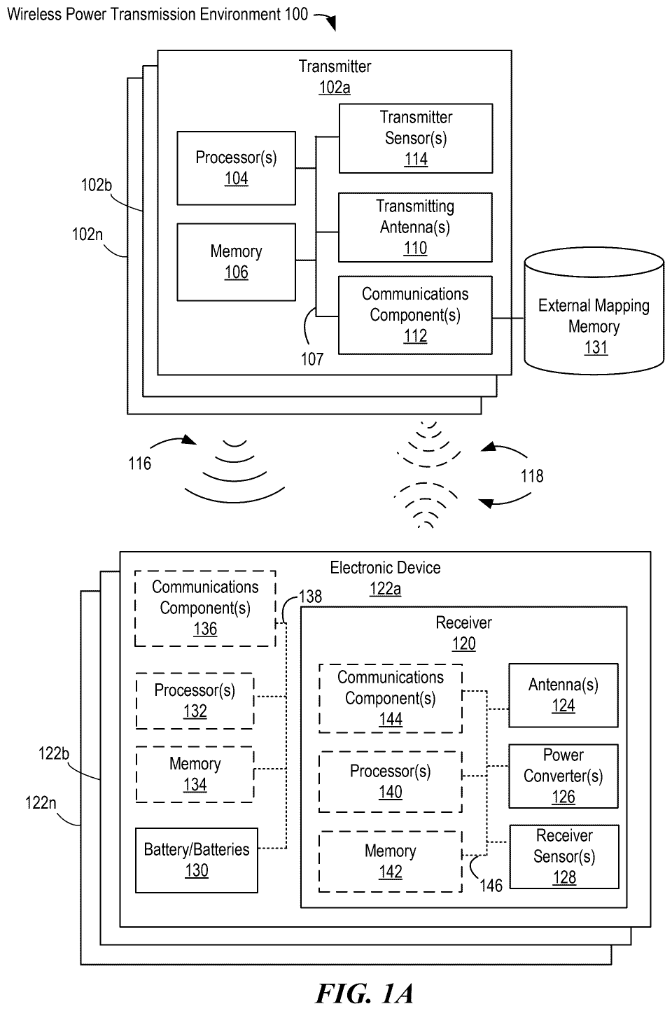

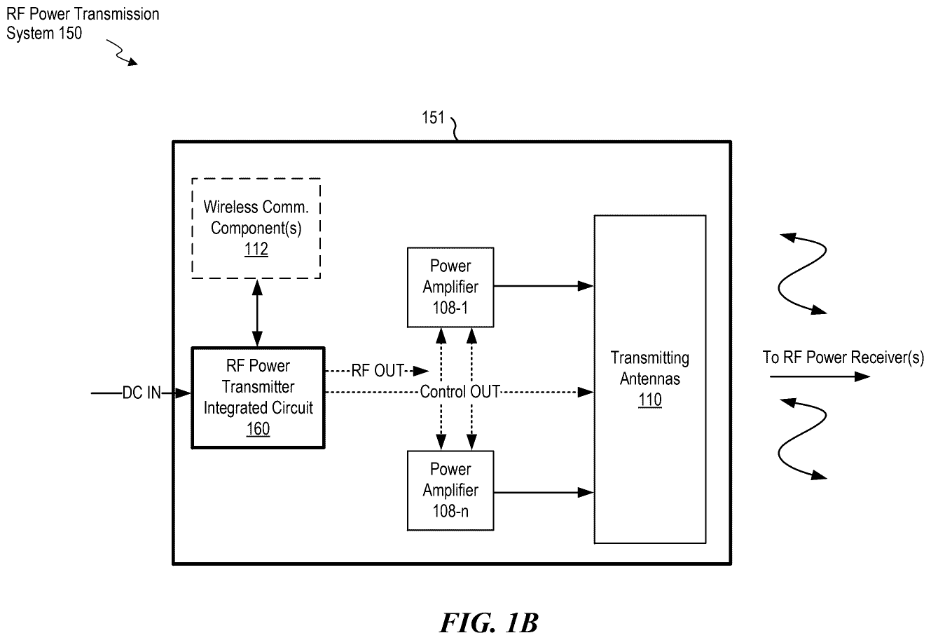

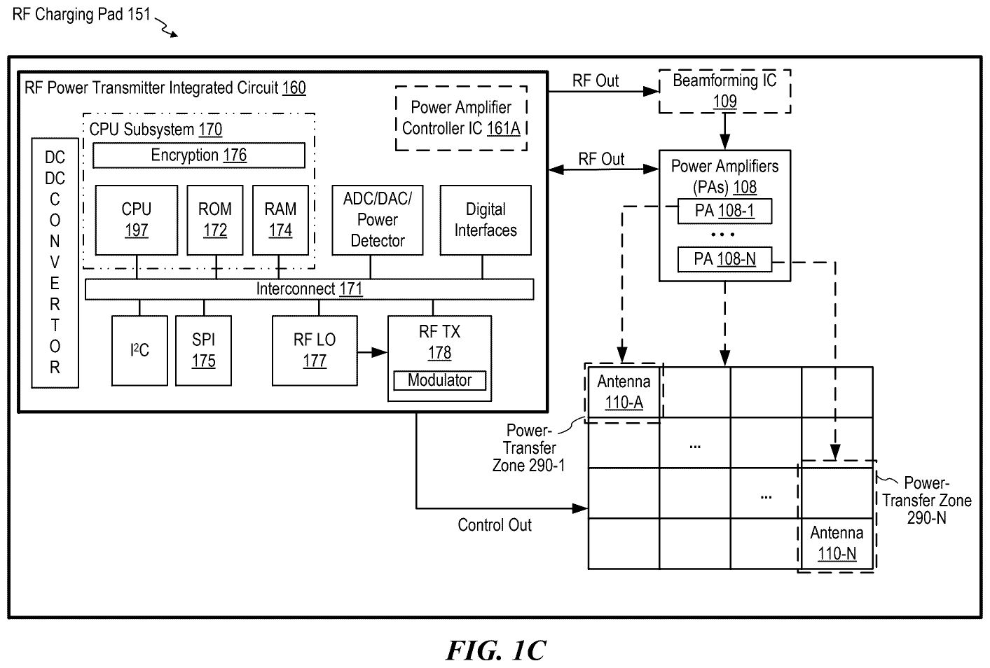

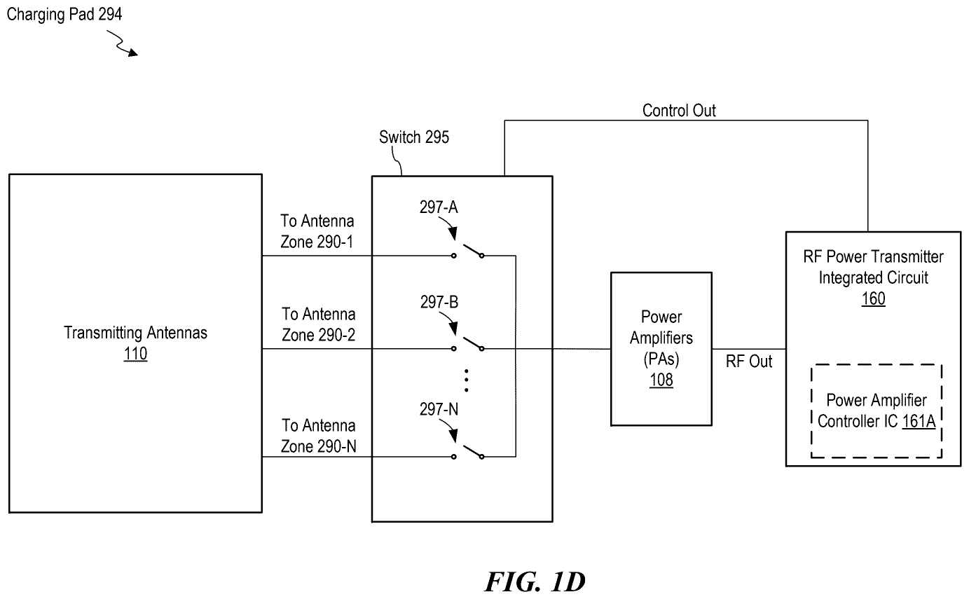

FIG. 1A is a block diagram of components of wireless power transmission environment 100, in accordance with some embodiments. Wireless power transmission environment 100 includes, for example, transmitters 102 (e.g., transmitters 102a, 102b . . . 102n) and one or more receivers 120 (e.g., receivers 120a, 120b . . . 120n). In some embodiments, the wireless power transmission environment 100 includes a number of receivers 120, each of which is associated with a respective electronic device 122. In some instances, the transmitter 102 is referred to herein as a “wireless-power-transmitting device,” a “wireless power transmitter,” and a “transmitting device.” Additionally, in some instances, the receiver 120 is referred to herein as a “wireless-power-receiving device,” a “wireless power receiver,” and a “receiving device.”

An example transmitter 102 (e.g., transmitter 102a) includes, for example, one or more processor(s) 104, a memory 106, one or more transmitting antennas 110, one or more communications components 112 (also referred to herein as a communications radio), and/or one or more transmitter sensors 114. In some embodiments, these components are interconnected by way of a communications bus 107. References to these components of transmitters 102 cover embodiments in which one or more of these components (and combinations thereof) are included.

In some embodiments, the memory 106 stores one or more programs (e.g., sets of instructions) and/or data structures. In some embodiments, the memory 106, or the non-transitory computer readable storage medium of the memory 106 stores the following programs, modules, and data structures, or a subset or superset thereof:
information received from receiver 120 (e.g., generated by receiver sensor 128 or processor 140, and then transmitted to the transmitter 102a);
information received from transmitter sensor 114;
an adaptive pocket-forming module that adjusts one or more power waves transmitted by one or more transmitters 102; and/or
a beacon transmitting module that transmits a communication signal 118 for detecting a receiver 120 (e.g., within a transmission field of the transmitter 102).

The above-identified modules (e.g., data structures and/or programs including sets of instructions) need not be implemented as separate software programs, procedures, or modules, and thus various subsets of these modules may be combined or otherwise re-arranged in various embodiments. In some embodiments, the memory 106 stores a subset of the modules identified above. In some embodiments, an external mapping memory 131 that is communicatively connected to communications component 112 stores one or more modules identified above. Furthermore, the memory 106 and/or external mapping memory 131 may store additional modules not described above. In some embodiments, the modules stored in the memory 106, or a non-transitory computer readable storage medium of memory 106, provide instructions for implementing respective operations. In some embodiments, some or all of these modules may be implemented with specialized hardware circuits that subsume part or all of the module functionality. One or more of the above-identified elements may be executed by one or more of processor(s) 104. In some embodiments, one or more of the modules described with regard to the memory 106 is implemented on the memory of a server (not shown) that is communicatively coupled to one or more transmitters 102 and/or by a memory of electronic device 122 and/or receiver 120.

In some embodiments, a single processor 104 (e.g., processor 104 of transmitter 102a) executes software modules for controlling multiple transmitters 102 (e.g., transmitters 102b . . . 102n). In some embodiments, a single transmitter 102 (e.g., transmitter 102a) includes multiple processors 104, such as one or more transmitter processors (configured to, e.g., control transmission of RF signals 116 by transmitting antenna(s) 110), one or more communications component processors (configured to, e.g., control communications transmitted by communications component 112 and/or receive communications by way of communications component 112) and/or one or more sensor processors (configured to, e.g., control operation of transmitter sensor 114 and/or receive output from transmitter sensor 114).

The wireless power receiver 120 receives power transmission signals 116 and/or communications 118 transmitted by transmitters 102. In some embodiments, the receiver 120 includes one or more antennas 124, power converters 126, receiver sensors 128, and/or other components or circuitry (e.g., processor(s) 140, memory 142, and/or communication component(s) 144). In some embodiments, these components are interconnected by way of a communications bus 146. References to these components of the receiver 120 cover embodiments in which one or more of these components (and combinations thereof) are included. The antennas 124 are discussed in further detail below, and may be referred to herein as receiving antennas 124. Note that while the discussion below concerns a single receiving antenna 124, it should be understood that the receiver 120 may include multiple instances of the receiving antenna 124 in an antenna array.

The receiver 120 converts energy from received signals 116 (also referred to herein as RF power transmission signals, or simply, RF signals, RF waves, electromagnetic (EM) power waves, power waves, or power transmission signals) into electrical energy to power and/or charge electronic device 122. For example, the receiver 120 uses the power converter 126 to convert energy derived from power waves 116 to alternating current (AC) electricity or direct current (DC) electricity usable to power and/or charge the electronic device 122. Non-limiting examples of the power converter 126 include rectifiers, rectifying circuits, voltage conditioners, among suitable circuitry and devices. The power converter 126 is also referred to herein as “conversion circuitry” and a “receiver integrated circuit.”

In some embodiments, the receiver 120 is a standalone device that is detachably coupled to one or more electronic devices 122. For example, the electronic device 122 has processor(s) 132 for controlling one or more functions of the electronic device 122, and the receiver 120 has processor(s) 140 for controlling one or more functions of the receiver 120. In some other embodiments, the receiver 120 is a component of the electronic device 122. For example, processors 132 control functions of the electronic device 122 and the receiver 120. In addition, in some embodiments, the receiver 120 includes one or more processors 140, which communicates with processors 132 of the electronic device 122.

In some embodiments, the electronic device 122 includes one or more processors 132, memory 134, one or more communication components 136, and/or one or more batteries 130. In some embodiments, these components are interconnected by way of a communications bus 138. In some embodiments, communications between the electronic device 122 and receiver 120 occur via communications component(s) 136 and/or 144. In some other embodiments, communications between the electronic device 122 and receiver 120 occur via a wired connection between communications bus 138 and communications bus 146. In some embodiments, the electronic device 122 and the receiver 120 share a single communications bus.

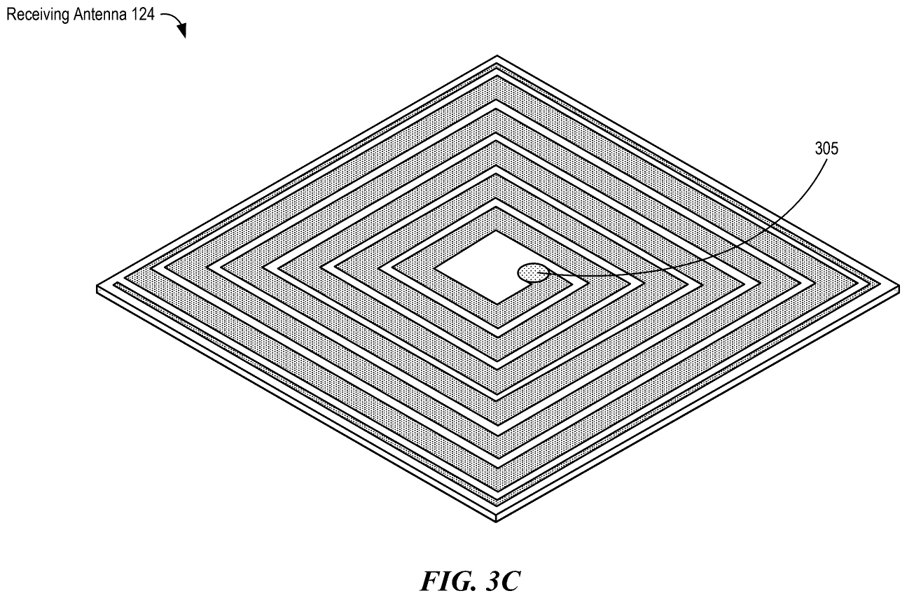

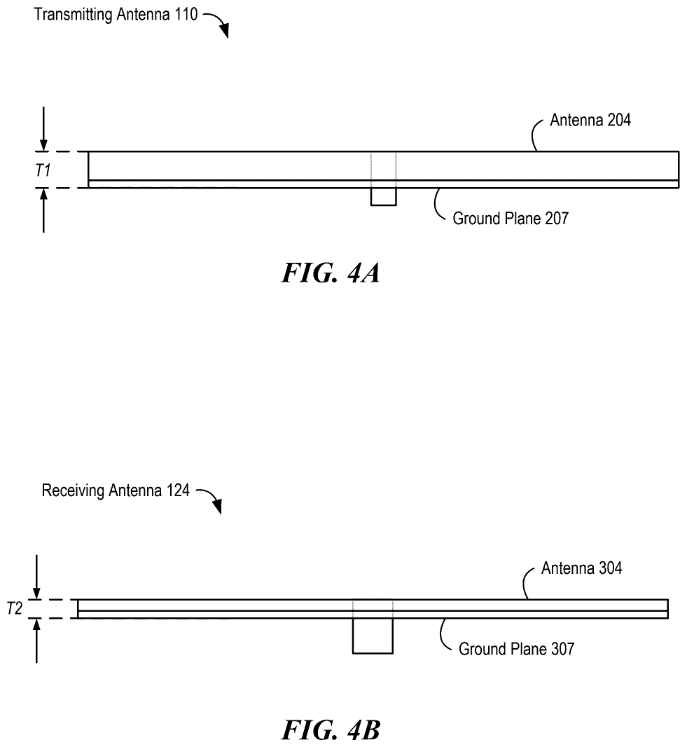

The receiver 120 is configured to receive one or more power waves 116 directly from the transmitter 102 (e.g., via one or more antennas 124). Furthermore, the receiver 120 is configured to harvest power waves from energy created by one or more power waves 116 transmitted by the transmitter 102. In some embodiments, the transmitter 102 is a near-field transmitter that transmits the one or more power waves 116 within a near-field distance (e.g., less than approximately six inches away from the transmitter 102, as shown in FIGS. 5 and 6). In some other embodiments, the transmitter 102 is a far-field transmitter that transmits the one or more power waves 116 within a far-field distance (e.g., more than approximately six inches away from the transmitter 102).

In some embodiments, after the power waves 116 are received and/or energy is harvested from the waves, circuitry 126 (e.g., integrated circuits, amplifiers, rectifiers, and/or voltage conditioner) of the receiver 120 converts the energy of the power waves to usable power (i.e., electricity), which powers the electronic device 122 and/or is stored to the battery 130 of the electronic device 122. In some embodiments, a rectifying circuit of the receiver 120 translates the electrical energy from AC to DC for use by the electronic device 122. In some embodiments, a voltage conditioning circuit increases or decreases the voltage of the electrical energy as required by the electronic device 122. In some embodiments, an electrical relay conveys electrical energy from the receiver 120 to the electronic device 122.

In some embodiments, the electronic device 122 obtains power from multiple transmitters 102 and/or using multiple receivers 120. In some embodiments, the wireless power transmission environment 100 includes a plurality of electronic devices 122, each having at least one respective receiver 120 that is used to harvest power waves from the transmitters 102 into usable power for charging the electronic devices 122.

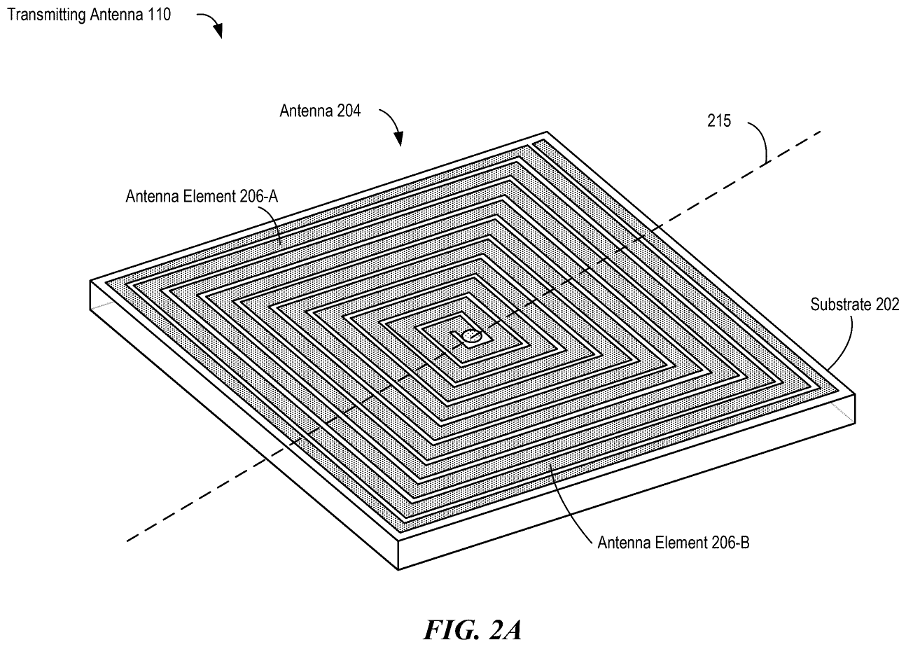

In some embodiments, the one or more transmitters 102 adjust values of one or more characteristics (e.g., waveform characteristics, such as phase, gain, direction, amplitude, polarization, and/or frequency) of power waves 116. For example, a transmitter 102 selects one or more transmitting antennas 110 to initiate transmission of power waves 116, cease transmission of power waves 116, and/or adjust values of one or more characteristics used to transmit power waves 116. In some embodiments, the one or more transmitters 102 adjust power waves 116 such that trajectories of power waves 116 converge at a predetermined location within a transmission field (e.g., a location or region in space), resulting in controlled constructive or destructive interference patterns. The transmitter 102 may adjust values of one or more characteristics for transmitting the power waves 116 to account for changes at the wireless power receiver 120 that may negatively impact transmission of the power waves 116. The transmitting antennas 110 are discussed in further detail below with respect to FIGS. 2A and 2B.

In some embodiments, the transmitting antennas 110 may include a set of one or more antennas configured to transmit the power waves 116 into respective transmission fields of the one or more transmitters 102. Integrated circuits (not shown) of the respective transmitter 102, such as a controller circuit (e.g., a radio frequency integrated circuit (RFIC)) and/or waveform generator, may control the behavior of the antennas 110. For example, based on the information received from the receiver 120 by way of the communication signal 118, a controller circuit (e.g., processor 104 of the transmitter 102, FIG. 1A) may determine values of the waveform characteristics (e.g., amplitude, frequency, trajectory, direction, phase, polarization, among other characteristics) of power waves 116 that would effectively provide power to the receiver 120, and in turn, the electronic device 122. The controller circuit may also identify which transmitting antennas 110 would be effective in transmitting the power waves 116. In some embodiments, a waveform generator circuit (not shown in FIG. 1A) of the respective transmitter 102 coupled to the processor 104 may convert energy and generate the power waves 116 having the specific values for the waveform characteristics identified by the processor 104/controller circuit, and then provide the power waves to the transmitting antennas 110 110 for transmission.

In some embodiments, constructive interference of power waves occurs when two or more power waves 116 (e.g., RF power transmission signals) are in phase with each other and converge into a combined wave such that an amplitude of the combined wave is greater than amplitude of a single one of the power waves. For example, the positive and negative peaks of sinusoidal waveforms arriving at a location from multiple antennas “add together” to create larger positive and negative peaks. In some embodiments, a pocket of energy is formed at a location in a transmission field where constructive interference of power waves occurs.

In contrast, destructive interference of power waves occurs when two or more power waves are out of phase and converge into a combined wave such that the amplitude of the combined wave is less than the amplitude of a single one of the power waves. For example, the power waves “cancel each other out,” thereby diminishing the amount of energy concentrated at a location in the transmission field. In some embodiments, destructive interference is used to generate a negligible amount of energy or “null” at a location within the transmission field where the power waves converge. Note that, in some embodiments, the transmitter 102 utilizes beamforming techniques to wirelessly transfer power to a receiver 120, while in other embodiments, the transmitter 102 does not utilize beamforming techniques to wirelessly transfer power to a receiver 120 (e.g., in circumstances in which no beamforming techniques are used, the transmitter controller IC 160 discussed below might be designed without any circuitry to allow for use of beamforming techniques, or that circuitry may be present, but might be deactivated to eliminate any beamforming control capability).

In some embodiments, the communications component 112 transmits communication signals 118 by way of a wired and/or wireless communication connection to the receiver 120. In some embodiments, the communications component 112 generates communication signals 118 used for triangulation of the receiver 120. In some embodiments, the communication signals 118 are used to convey information between the transmitter 102 and receiver 120 for adjusting values of one or more waveform characteristics used to transmit the power waves 116. In some embodiments, the communication signals 118 include information related to status, efficiency, user data, power consumption, billing, geo-location, and other types of information.

In some embodiments, the communications component 112 includes a communications component antenna for communicating with the receiver 120 and/or other transmitters 102 (e.g., transmitters 102b through 102n). In some embodiments, these communication signals 118 are sent using a first channel (e.g., a first frequency band) that is independent and distinct from a second channel (e.g., a second frequency band distinct from the first frequency band) used for transmission of the power waves 116.

In some embodiments, the receiver 120 includes a receiver-side communications component 144 configured to communicate various types of data with one or more of the transmitters 102, through a respective communication signal 118 generated by the receiver-side communications component (in some embodiments, a respective communication signal 118 is referred to as an advertising signal). The data may include location indicators for the receiver 120 and/or electronic device 122, a power status of the device 122, status information for the receiver 120, status information for the electronic device 122, status information about the power waves 116, and/or status information for pockets of energy. In other words, the receiver 120 may provide data to the transmitter 102, by way of the communication signal 118, regarding the current operation of the system 100, including: information identifying a present location of the receiver 120 or the device 122, an amount of energy (i.e., usable power) received by the receiver 120, and an amount of usable power received and/or used by the electronic device 122, among other possible data points containing other types of information.

In some embodiments, the data contained within communication signals 118 is used by the electronic device 122, the receiver 120, and/or the transmitters 102 for determining adjustments to values of one or more waveform characteristics used by the transmitting antennas 110 to transmit the power waves 116. Using a communication signal 118, the transmitter 102 communicates data that is used, e.g., to identify receivers 120 within a transmission field, identify electronic devices 122, determine safe and effective waveform characteristics for power waves, and/or hone the placement of pockets of energy. In some embodiments, the receiver 120 uses a communication signal 118 to communicate data for alerting transmitters 102 that the receiver 120 has entered or is about to enter a transmission field, provide information about the electronic device 122, provide user information that corresponds to the electronic device 122, indicate the effectiveness of received power waves 116, and/or provide updated characteristics or transmission parameters that the one or more transmitters 102 use to adjust transmission of the power waves 116.

In some embodiments, transmitter sensor 114 and/or receiver sensor 128 detect and/or identify conditions of the electronic device 122, the receiver 120, the transmitter 102, and/or a transmission field. In some embodiments, data generated by the transmitter sensor 114 and/or receiver sensor 128 is used by the transmitter 102 to determine appropriate adjustments to values of waveform characteristics used to transmit the power waves 116. Data from transmitter sensor 114 and/or receiver sensor 128 received by the transmitter 102 includes, e.g., raw sensor data and/or sensor data processed by a processor 104, such as a sensor processor. Processed sensor data includes, e.g., determinations based upon sensor data output. In some embodiments, sensor data received from sensors that are external to the receiver 120 and the transmitters 102 is also used (such as thermal imaging data, information from optical sensors, and others).

In some embodiments, the receiver sensor 128 is a gyroscope that provides raw data such as orientation data (e.g., tri-axial orientation data), and processing this raw data may include determining a location of the receiver 120 and/or or a location of receiver antenna 124 using the orientation data. Furthermore, the receiver sensor 128 can indicate an orientation of the receiver 120 and/or electronic device 122. As one example, the transmitters 102 receive orientation information from the receiver sensor 128 and the transmitters 102 (or a component thereof, such as the processor 104) use the received orientation information to determine whether electronic device 122 is flat on a table, in motion, and/or in use (e.g., next to a user's head).

Non-limiting examples of the transmitter sensor 114 and/or the receiver sensor 128 include, e.g., infrared, pyroelectric, ultrasonic, laser, optical, Doppler, gyro, accelerometer, microwave, millimeter, RF standing-wave sensors, resonant LC sensors, capacitive sensors, and/or inductive sensors. In some embodiments, technologies for the transmitter sensor 114 and/or the receiver sensor 128 include binary sensors that acquire stereoscopic sensor data, such as the location of a human or other sensitive object.

In some embodiments, the transmitter sensor 114 and/or receiver sensor 128 is configured for human recognition (e.g., capable of distinguishing between a person and other objects, such as furniture). Examples of sensor data output by human recognition-enabled sensors include: body temperature data, infrared range-finder data, motion data, activity recognition data, silhouette detection and recognition data, gesture data, heart rate data, portable devices data, and wearable device data (e.g., biometric readings and output, accelerometer data).

FIG. 1B is another block diagram of an RF wireless power transmission system 150 in accordance with some embodiments. In some embodiments, the RF wireless power transmission system 150 includes a far-field transmitter (not shown). In some embodiments, the RF wireless power transmission system 150 includes a RF charging pad 151 (also referred to herein as a near-field (NF) charging pad 151 or RF charging pad 151). The RF charging pad 151 may be an example of the transmitter 102 in FIG. 1A.

In some embodiments, the RF charging pad 151 includes an RF power transmitter integrated circuit 160 (described in more detail below). In some embodiments, the RF charging pad 151 includes one or more communications components 112 (e.g., wireless communication components, such as WI-FI or BLUETOOTH radios). In some embodiments, the RF charging pad 151 also connects to one or more power amplifier units 108-1, . . . 108-n (PA or PA units) to control operation of the one or more power amplifier units when they drive external power-transfer elements (e.g., antennas 110). In some embodiments, RF power is controlled and modulated at the RF charging pad 151 via switch circuitry as to enable the RF wireless power transmission system to send RF power to one or more wireless receiving devices via the TX antenna array 110.

FIG. 1C is a block diagram of the RF power transmitter integrated circuit 160 (the “integrated circuit”) in accordance with some embodiments. In some embodiments, the integrated circuit 160 includes a CPU subsystem 170, an external device control interface, an RF subsection for DC to RF power conversion, and analog and digital control interfaces interconnected via an interconnection component, such as a bus or interconnection fabric block 171. In some embodiments, the CPU subsystem 170 includes a microprocessor unit (CPU) 197 with related Read-Only-Memory (ROM) 172 for device program booting via a digital control interface, e.g. an 12C port, to an external FLASH containing the CPU executable code to be loaded into the CPU Subsystem Random Access Memory (RAM) 174 or executed directly from FLASH. In some embodiments, the CPU subsystem 170 also includes an encryption module or block 176 to authenticate and secure communication exchanges with external devices, such as wireless power receivers that attempt to receive wirelessly delivered power from the RF charging pad 150.

In some embodiments, the RF IC 160 also includes (or is in communication with) a power amplifier controller IC 161A (PA IC) that is responsible for controlling and managing operations of a power amplifier (or multiple power amplifiers), including for reading measurements of impedance at various measurement points within the power amplifier 108, whereby these measurements are used, in some instances, for detecting of foreign objects. The PA IC 161A may be on the same integrated circuit at the RF IC 160, or may be on its on integrated circuit that is separate from (but still in communication with) the RF IC 160.

In some embodiments, executable instructions running on the CPU (such as those shown in the memory 106 in FIG. 2 and described below) are used to manage operation of the RF charging pad 151 and to control external devices through a control interface, e.g., SPI control interface 175, and the other analog and digital interfaces included in the RF power transmitter integrated circuit 160. In some embodiments, the CPU subsystem also manages operation of the RF subsection of the RF power transmitter integrated circuit 160, which includes an RF local oscillator (LO) 177 and an RF transmitter (TX) 178. In some embodiments, the RF LO 177 is adjusted based on instructions from the CPU subsystem 170 and is thereby set to different desired frequencies of operation, while the RF TX converts, amplifies, modulates the RF output as desired to generate a viable RF power level.

In the descriptions that follow, various references are made to antenna zones and power-transfer zones, which terms are used synonymously in this disclosure. In some embodiments the antenna/power-transfer zones may include antenna elements that transmit propagating radio frequency waves but, in other embodiments, the antenna/power transfer zones may instead include capacitive charging couplers that convey electrical signals but do not send propagating radio frequency waves.

In some embodiments, the RF power transmitter integrated circuit 160 provides the viable RF power level (e.g., via the RF TX 178) to an optional beamforming integrated circuit (IC) 109, which then provides phase-shifted signals to one or more power amplifiers 108. In some embodiments, the beamforming IC 109 is used to ensure that power transmission signals sent using two or more antennas 110 (e.g., each antenna 110 may be associated with a different antenna zone 290 or may each belong to a single antenna zone 290) to a particular wireless power receiver are transmitted with appropriate characteristics (e.g., phases) to ensure that power transmitted to the particular wireless power receiver is maximized (e.g., the power transmission signals arrive in phase at the particular wireless power receiver). In some embodiments, the beamforming IC 109 forms part of the RF power transmitter IC 160. In embodiments in which capacitive couplers are used as the antennas 110, then optional beamforming IC 109 may not be included in the RF power transmitter integrated circuit 160.

In some embodiments, the RF power transmitter integrated circuit 160 provides the viable RF power level (e.g., via the RF TX 178) directly to the one or more power amplifiers 108 and does not use the beamforming IC 109 (or bypasses the beamforming IC if phase-shifting is not required, such as when only a single antenna 110 is used to transmit power transmission signals to a wireless power receiver). In some embodiments, the PA IC 161A receives the viable RF power level and provides that to the one or more power amplifiers 108.

In some embodiments, the one or more power amplifiers 108 then provide RF signals to the antenna zones 290 (also referred to herein as “power-transfer zones”) for transmission to wireless power receivers that are authorized to receive wirelessly delivered power from the RF charging pad 151. In some embodiments, each antenna zone 290 is coupled with a respective PA 108 (e.g., antenna zone 290-1 is coupled with PA 108-1 and antenna zone 290-N is coupled with PA 108-N). In some embodiments, multiple antenna zones are each coupled with a same set of PAs 108 (e.g., all PAs 108 are coupled with each antenna zone 290). Various arrangements and couplings of PAs 108 to antenna zones 290 allow the RF charging pad 151 to sequentially or selectively activate different antenna zones in order to determine the most efficient antenna zone 290 to use for transmitting wireless power to a wireless power receiver. In some embodiments, the one or more power amplifiers 108 are also in communication with the CPU subsystem 170 to allow the CPU 197 to measure output power provided by the PAs 108 to the antenna zones 110 of the RF charging pad 151.

FIG. 1C also shows that, in some embodiments, the antenna zones 290 of the RF charging pad 151 may include one or more antennas 110A-N. In some embodiments, each antenna zone of the plurality of antenna zones 290 includes one or more antennas 110 (e.g., antenna zone 290-1 includes one antenna 110-A and antenna zones 290-N includes multiple antennas 110). In some embodiments, a number of antennas included in each of the antenna zones is dynamically defined based on various parameters, such as a location of a wireless power receiver on the RF charging pad 151. In some embodiments, each antenna zone 290 may include antennas of different types, while in other embodiments each antenna zone 290 may include a single antenna of a same type, while in still other embodiments, the antennas zones may include some antenna zones that include a single antenna of a same type and some antenna zones that include antennas of different types. In some embodiments the antenna/power-transfer zones may also or alternatively include capacitive charging couplers that convey electrical signals but do not send propagating radio frequency waves.

In some embodiments, the RF charging pad 151 may also include a temperature monitoring circuit that is in communication with the CPU subsystem 170 to ensure that the RF charging pad 151 remains within an acceptable temperature range. For example, if a determination is made that the RF charging pad 151 has reached a threshold temperature, then operation of the RF charging pad 151 may be temporarily suspended until the RF charging pad 151 falls below the threshold temperature.

By including the components shown for RF power transmitter circuit 160 (FIG. 1C) on a single chip, such transmitter chips are able to manage operations at the transmitter chips more efficiently and quickly (and with lower latency), thereby helping to improve user satisfaction with the charging pads that are managed by these transmitter chips. For example, the RF power transmitter circuit 160 is cheaper to construct, has a smaller physical footprint, and is simpler to install.

FIG. 1D is a block diagram of a charging pad 294 in accordance with some embodiments. The charging pad 294 is an example of the charging pad 151 (FIG. 1B), however, one or more components included in the charging pad 151 are not included in the charging pad 294 for ease of discussion and illustration.

The charging pad 294 includes an RF power transmitter integrated circuit 160, one or more power amplifiers 108, a PA IC 161A (which may be on the same or a separate IC from the RF power transmitter IC 160), and multiple transmitting antennas 110 that are divided into multiple antenna zones. Each of these components is described in detail above with reference to FIGS. 1A-1C. Additionally, the charging pad 294 includes a switch 295 (i.e., transmitter-side switch), positioned between the power amplifiers 108 and the transmitting antennas 110, having a plurality of switches 297-A, 297-B, . . . 297-N. The switch 295 is configured to switchably connect one or more power amplifiers 108 with one or more antenna zones 290 in response to control signals provided by the RF power transmitter integrated circuit 160.

To accomplish the above, each switch 297 is coupled with (e.g., provides a signal pathway to) a different antenna zone of the array 110. For example, switch 297-A may be coupled with a first antenna zone 290-1 (FIG. 1C) of the array 110, switch 297-B may be coupled with a second antenna zone 290-2 of the array 110, and so on. Each of the plurality of switches 297-A, 297-B, . . . 297-N, once closed, creates a unique pathway between a respective power amplifier 108 (or multiple power amplifiers 108) and a respective antenna zone of the array 110. Each unique pathway through the switch 295 is used to selectively provide RF signals to specific antenna zones. It is noted that two or more of the plurality of switches 297-A, 297-B, . . . 297-N may be closed at the same time, thereby creating multiple unique pathways to the multiple transmitting antennas 110 that may be used simultaneously.

In some embodiments, the RF power transmitter integrated circuit 160 (or the PA IC 161A, or both) is (are) coupled to the switch 295 and is configured to control operation of the plurality of switches 297-A, 297-B, . . . 297-N (illustrated as a “control out” signal in FIGS. 1B and 1D). For example, the RF power transmitter integrated circuit 160 may close a first switch 297-A while keeping the other switches open. In another example, the RF power transmitter integrated circuit 160 may close a first switch 297-A and a second switch 297-B, and keep the other switches open (various other combinations and configuration are possible). Moreover, the RF power transmitter integrated circuit 160 is coupled to the one or more power amplifiers 108 and is configured to generate a suitable RF signal (e.g., the “RF Out” signal) and provide the RF signal to the one or more power amplifiers 108. The one or more power amplifiers 108, in turn, are configured to provide the RF signal to one or more antenna zones of the array 110 via the switch 295, depending on which switches 297 in the switch 295 are closed by the RF power transmitter integrated circuit 160.

In some embodiments, the charging pad is configured to transmit test power transmission signals and/or regular power transmission signals using different antenna zones, e.g., depending on a location of a receiver on the charging pad. Accordingly, when a particular antenna zone is selected for transmitting test signals or regular power signals, a control signal is sent to the switch 295 from the RF power transmitter integrated circuit 160 to cause at least one switch 297 to close. In doing so, an RF signal from at least one power amplifier 108 can be provided to the particular antenna zone using a unique pathway created by the now-closed at least one switch 297.

In some embodiments, the switch 295 may be part of (e.g., internal to) the multiple transmitting antennas 110. Alternatively, in some embodiments, the switch 295 is separate from the multiple transmitting antennas 110 (e.g., the switch 295 may be a distinct component, or may be part of another component, such as the power amplifier(s) 108). It is noted that any switch design capable of accomplishing the above may be used, and the design of the switch 295 illustrated in FIG. 1D is merely one example.

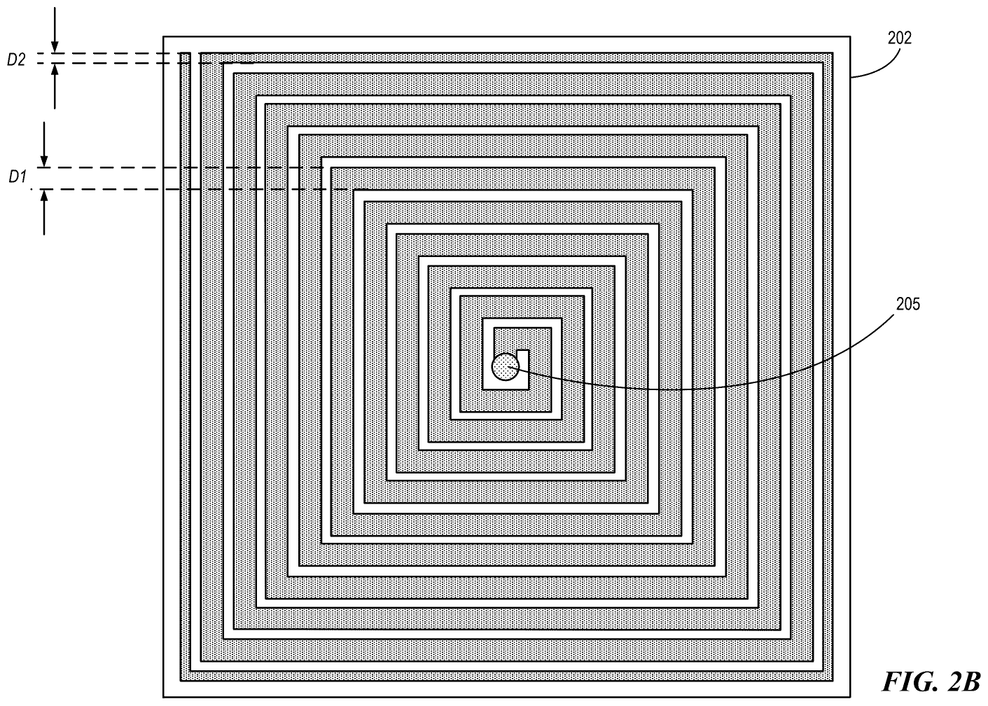

The remaining figures below cover various implementations of the wireless power transmission environment 100 discussed above. For example, FIGS. 2A through 3B shows various views of an example near-field power transfer system (i.e., one implementation of the wireless power transmission environment 100). Specifically, FIG. 2A shows a top perspective view of a transmitting antenna 110 used in the example near-field power transfer system. In some embodiments, the transmitting antenna 110 is housed by a housing constructed of a material creating minimal obstructions for electromagnetic waves to pass through. In other embodiments, different portions of the housing may be constructed with materials having different electromagnetic properties such as permeability and permittivity. As one example, a top surface of the housing may allow electromagnetic waves to pass through with minimal obstruction while the sidewalls of the housing may obstruct electromagnetic waves by attenuation, absorption, reflection, or other techniques known in the art.

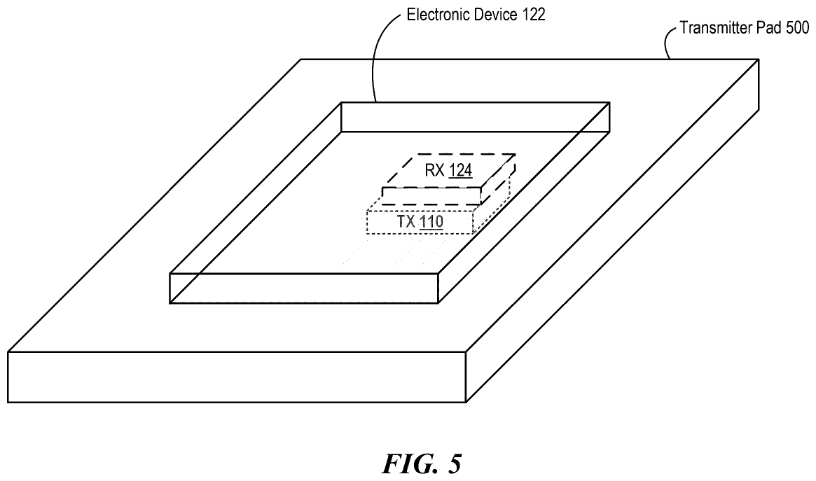

The transmitting antenna 110 is configured to radiate RF energy (e.g., electromagnetic waves/signals), and thus transfer power when adjacent to a receiving antenna 124 (discussed below with reference to FIGS. 3A to 3C). As such, the transmitting antenna 110 may be on a “transmit side,” so as to function as a power transmitter, and the receiving antenna 124 may be on a “receive side,” so as to function as a power receiver. In some embodiments, the transmitting antenna 110 (or subcomponents of the transmitting antenna 110) may be integrated into a transmitter device 102, or may be externally wired to the transmitter device 102. As will be discussed in more detail below with reference to FIG. 7A and FIG. 7B, the example near-field power transfer system can achieve an energy transfer efficiency of 90% or higher, despite being configured to operate at low frequencies, such as 40 MHz.

A substrate 202 may be disposed within a space defined between the top surface, sidewalls, and the bottom surface of the housing. In some embodiments, the transmitting antenna 110 may not include the housing and instead the substrate 202 may include the top surface, sidewalls, and the bottom surface. The substrate 202 may comprise any material capable of insulating, reflecting, absorbing, or otherwise housing electrical lines conducting current, such as metamaterials. The metamaterials may be a broad class of synthetic materials that are engineered to yield desirable magnetic permeability and electrical permittivity. At least one of the magnetic permeability and electrical permittivity may be based upon power-transfer requirements, and/or compliance constraints for government regulations. The metamaterials disclosed herein may receive radiation or may generate radiation, and may act as reflectors.

The transmitting antenna 110 includes an antenna 204 (also referred to herein as a “radiator element,” or a “radiator”). The antenna 204 may be constructed on or below the top surface of the housing (or the substrate 202). The antenna 204 may be used for transmitting electromagnetic waves (e.g., waves 116). The antenna 204 may be constructed from materials such as metals, alloys, metamaterials and composites. For example, the antenna 204 may be made of copper or copper alloys. The antenna 204 may be constructed to have different shapes based on power transfer requirements. For example, in FIGS. 2A and 2B, the antenna 204 is constructed in a shape of a spiral including antenna elements 206 (also referred to herein as “antenna segments”) that are disposed close to each other. In the illustrated embodiment, the antenna 204 includes ten full turns (i.e., ten complete revolutions). It is noted that various turn amounts can be used, so long as the number of turns is greater than the number of turns made by an antenna 304 of the receiving antenna 124. As will be discussed in further detail below, a higher coupling efficiency is achieved by designing the antenna 204 to have more turns than the antenna 304 of the receiving antenna 124 (along with other changes to the design of the antennas 204 and 304, such as width of antenna segments, antenna thickness, location of feeds, and material selection). The spiral shape of the antenna elements 206 is planar, meaning that each revolution of the antenna 204 is on the same plane. Furthermore, while the spiral shape of the antenna elements 206 is rectangular in FIGS. 2A and 2B, the spiral shape may be various other shapes. It is noted that, in some embodiments, the antenna elements 206 (and antenna elements 306) are formed by grounded lines and are much smaller than a wavelength of the transmitted electromagnetic waves.

In some embodiments, a width of antenna elements 206 varies from one turn to the next. Put another way, a surface area of a respective antenna element 206 of the antenna 204 differs from a surface area of at least one other antenna element 206 of the antenna 204. For example, with reference to FIG. 2B, the outer most antenna element 206 of the antenna 204 has a width of D¹, while the other antenna elements of the antenna 204 each has a width of D², which is greater than the width of D¹ (i.e., the outer most revolution of the antenna 204 in thinner than other revolutions of the antenna 204). In some embodiments, each revolution of the antenna 204 may have a different width (e.g., a width of the antenna 204 may progressively increase (or decrease) with each revolution of the antenna 204). Varying the widths of the antenna elements 206 can be used to adjust a surface area of the antenna 206, and in turn, adjust an operating frequency of the antenna 206. In some embodiments, a surface area of each antenna element 206 is optimized according to a design of the antenna 304 of the receiving antenna 124. It is noted that, in some embodiments, the antenna 204 is continuous (e.g., a continuous spiral), while in other embodiments the antenna 204 is composed of contiguous antenna segments 206.

Currents flowing through the antenna elements 206 may be in opposite directions. For example, if the current in antenna element 206-A is flowing from left to right in FIG. 2A, the current in antenna element 206-B (and its adjacent elements) may be flowing from right to left. In some embodiments (e.g., when the transmitting antenna 110 and the receiving antenna 124 are separated from each other by a non-zero distance), since the antenna elements 206 are formed by grounded lines and are much smaller than the wavelength, and due to the opposite flow of current through the transmitting antenna 110, substantially all (e.g., 85%, 90%, 95%, or more) of the electromagnetic radiation in a far-field region of the transmitting antenna 110 gets cancelled. As one example, the far-field electromagnetic radiation generated by one or more antenna elements 206 left of an imaginary line 215 is cancelled out by the far-field electromagnetic radiation generated by one or more antenna elements 206 right of the line 215. In some other embodiments (e.g., when the receiving antenna 124 is positioned on the transmitting antenna 110), opposite flows of current results in cancellation of a portion of the current (e.g., an undesired portion of the current that should not be transmitted to the receiving antenna 124). In either embodiment, transmission of electromagnetic radiation into the far-field region from the transmitting antenna 110 is substantially eliminated (e.g., 85%, 90%, 95%, or more of all far-field electromagnetic radiation from the transmitting antenna 110 is eliminated). Such cancellation, however, may not occur in a near-field active zone of the transmitting antenna 110, where the transfer of power may occur (e.g., between the transmitting antenna 110 and the receiving antenna 124). Thus, the spiral design of the transmitting antenna 110 facilitates wireless charging using electromagnetic energy, while also minimizing propagation of electromagnetic energy away from a desired charging space (i.e., minimizing propagation of electromagnetic energy into the far field).

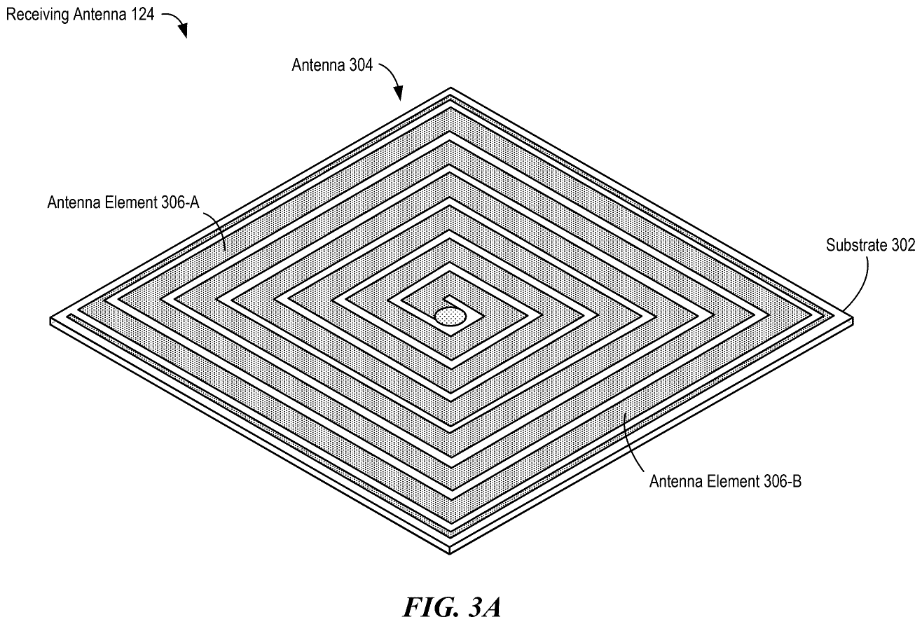

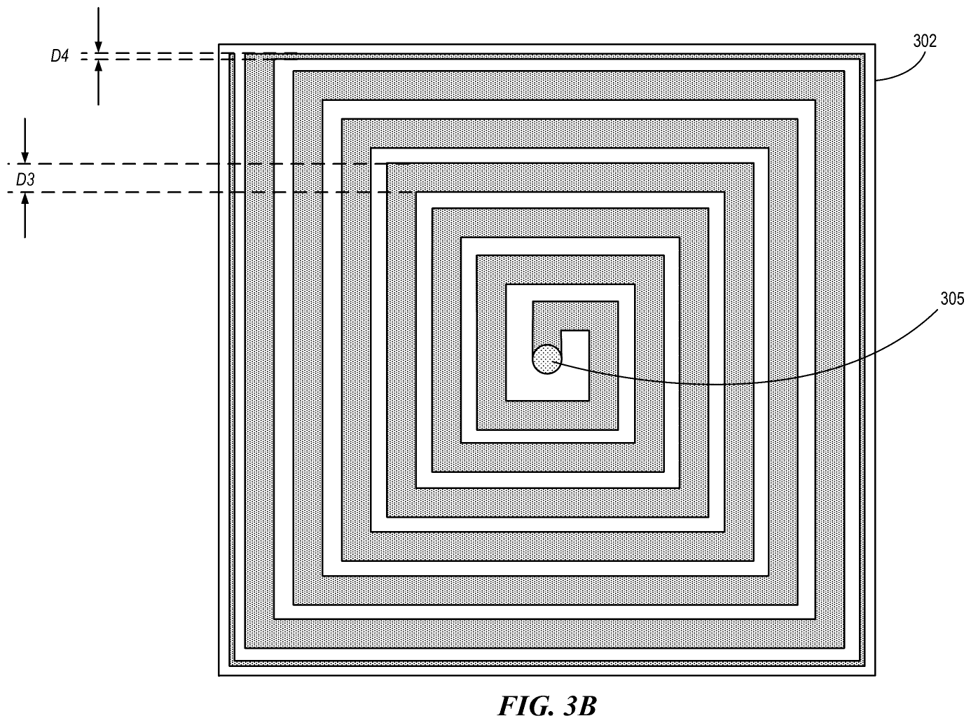

In some embodiments, the transmitting antenna 110 includes a ground plane 207 (shown in FIG. 4A) at or above a bottom surface of the substrate 202. The ground plane 207 may be formed by materials such as metal, alloys, and composites. In an embodiment, the ground plane 207 may be formed by copper or a copper alloy. In some embodiments, the ground plane 207 may be constructed of a solid sheet of material. In other embodiments, the ground plane 207 may be constructed using material strips arranged in shapes such as loops, spirals, and meshes. As shown in FIG. 2B, a via 205 carrying a power feed line (not shown) to the antenna 204 may pass through the ground plane 207. The power feed line may supply current to the antenna 204. In some embodiments, the ground plane 207 may be electrically connected to the antenna 204. In some embodiments, the ground plane 207 may not be electrically connected to the antenna 204. In such embodiments, the via 205 is separated and insulated from the ground plane 207. In some embodiments, the ground plane 207 may act as a reflector of electromagnetic waves generated by the antenna 204. In other words, the ground plane 207 may not allow electromagnetic transmission beyond the bottom surface of the transmitting antenna 110 by cancelling and/or reflecting the transmission image formed beyond the bottom surface. Reflecting electromagnetic waves by the ground plane 207 may reinforce the electromagnetic waves transmitted by the antenna 204 from or towards the top surface of the substrate 202. Therefore, leakage of electromagnetic power from the bottom surface of the substrate 202 is minimized, and in some cases, eliminated. The via 205 may be positioned in a center of the substrate 202 (as shown in FIG. 2B) or the via 205 may be offset from the substrate 202's center in one or more directions.

Due to the arrangement of the antenna 204 and the ground plane 207, electromagnetic waves transmitted by the transmitting antenna 110 accumulate in the near field of the transmitting antenna 110. Importantly (e.g., for compliance with safety regulations governing wireless charging), leakage of electromagnetic energy into the far field is minimized or eliminated (for the reasons discussed above).

FIG. 3A shows a top perspective view of a receiving antenna 124 used in the example near-field power transfer system. In some embodiments, the receiving antenna 124 is housed by a housing constructed of a material creating minimal obstructions for electromagnetic waves to pass through. In other embodiments, different portions of the housing may be constructed with materials having different electromagnetic properties such as permeability and permittivity. As one example, a top surface of the housing may allow electromagnetic waves to pass through with minimal obstruction while the sidewalls of the housing may obstruct electromagnetic waves by attenuation, absorption, reflection, or other techniques known in the art.

The receiving antenna 124 is configured to receive RF energy (e.g., electromagnetic waves/signals), and thus receive power when adjacent to the transmitting antenna 110 (discussed above with reference to FIGS. 2A to 2B). FIG. 5 shows one example of an electronic device 122, with a receiving antenna 124 integrated therein, positioned on a transmitted pad 500 (e.g., one example of the transmitter 102, FIG. 1A), having a transmitting antenna 110 integrated therein. As shown, the receiving antenna 124 is adjacent to the transmitting antenna 110, and in this arrangement, wireless power transfer occurs with high efficiency (e.g., greater than 90% efficiency). In some embodiments, the receiving antenna 124 (or subcomponents of the receiving antenna 124) may be integrated into a receiver device 120, or may be externally wired to the receiver device 120 (FIG. 1A). While not shown in FIG. 5, the transmitting antenna 110 and the receiving antenna 124 may be embedded in their respective devices (e.g., the transmitter 102 and the receiver 120).

The receiving antenna 124 may include a substrate 302, which can be disposed within a space defined between the top surface, sidewalls, and the bottom surface of the housing. In some embodiments, the receiving antenna 124 may not include the housing and instead the substrate 302 may include the top surface, sidewalls, and the bottom surface. The substrate 302 may comprise any material capable of insulating, reflecting, absorbing, or otherwise housing electrical lines conducting current, such as metamaterials. The metamaterials may be a broad class of synthetic materials that are engineered to yield desirable magnetic permeability and electrical permittivity. At least one of the magnetic permeability and electrical permittivity may be based upon power-transfer requirements, and/or compliance constraints for government regulations. The metamaterials disclosed herein may receive radiation or may generate radiation, and may act as thin reflectors.

The receiving antenna 124 includes an antenna 304 (also referred to herein as a “radiator element,” or a “radiator”). The antenna 304 may be constructed on or below the top surface of the housing (or the substrate 302). As mentioned above, the receiving antenna 124 is associated with power receiving, and thus, the antenna 304 is used for receiving electromagnetic waves (e.g., waves 116). The antenna 304 may be constructed from materials such as metals, alloys, metamaterials and composites. For example, the antenna 304 may be made of copper or copper alloys. The antenna 304 may be constructed to have different shapes based on power transfer requirements. For example, in FIGS. 3A and 3B, the antenna 304 is constructed in a shape of a spiral including antenna elements 306 (also referred to herein as “antenna segments”) that are disposed close to each other. In the illustrated embodiment, the antenna 304 includes six full turns (i.e., six complete revolutions). It is noted that various turn amounts can be used, so long as the number of turns is less than the number of turns made by the antenna 204 of the transmitting antenna 110.

In some embodiments, a width of antenna elements 306 varies from one turn to the next. Put another way, a surface area of a respective antenna element 306 may differ from a surface area of at least one other antenna element 306. For example, with reference to FIG. 3B, the outer most antenna element 306 of the antenna 304 has a width of D4, while the other antenna elements each has a width of D3, which is greater than the width of D4. In some embodiments, each revolution of the antenna 304 may have a different width (e.g., a width of the antenna 304 may progressively increase (or decrease) with each revolution of the antenna 304). Varying the widths of the antenna elements 306 can be used to adjust a surface area of the antenna 304, and in turn, adjust an operating frequency of the antenna 304. In some embodiments, an arrangement of the antenna elements 306 (e.g., the number of turns) and a surface area of each antenna element 306 are optimized according to a design of the antenna 204 of the transmitting antenna 110. It is noted that, in some embodiments, the antenna 304 is continuous (e.g., a continuous spiral) while in other embodiments the antenna 304 is composed of contiguous antenna segments 306.

Much like the transmitting antenna 110, in some embodiments, the receiving antenna 124 includes a ground plane 307 (shown in FIG. 4B) at or above a bottom surface of the substrate 302. The ground plane 307 may be formed by materials such as metal, alloys, and composites. In some embodiments, the ground plane 307 may be formed by copper or a copper alloy. In some embodiments, the ground plane 307 may be constructed of a solid sheet of material. In other embodiments, the ground plane 307 may be constructed using material strips arranged in shapes such as loops, spirals, and meshes. As shown in FIG. 3B, a via 305 carrying a power feed line (not shown) to the antenna 304 may pass through the ground plane 307. The power feed line may receive current from the antenna 304. In some embodiments, the ground plane 307 may be electrically connected to the antenna 304. In some embodiments, the ground plane 307 may not be electrically connected to the antenna 304. In such embodiments, the via 305 is separated and insulated from the ground plane 307. In some embodiments, the ground plane 307 may act as a reflector. In other words, the ground plane 307 may not allow electromagnetic transmission beyond the bottom surface of the receiving antenna 124 by cancelling and/or reflecting the transmission image formed beyond the bottom surface. Reflecting the electromagnetic waves by the ground plane 307 may reinforce the electromagnetic waves received by the antenna 304.

The via 305 may be positioned in a center of the substrate 302 (as shown in FIG. 3B) or the via 305 may be offset from the substrate 302's center in one or more directions (as shown in FIG. 3C).

FIG. 3C shows another embodiment of the receiving antenna 124. Specifically, in FIG. 3C, the via 305 is not positioned in a center of the substrate 302. Instead, the via 305 is offset towards one or more of the sides of the substrate 302. In doing so, the via 305 is not coaxially aligned with the via 205 of the transmitting antenna 110, e.g., when the transmitting antenna 110 and the receiving antenna 124 are positioned adjacent each other. The coaxial misalignment between the via 205 and the via 305 can be used to optimize the matching of the antennas in asymmetrical port assignment (i.e. where each antenna is terminated with a different port impedances).

FIGS. 4A and 4B show cross-sectional views of the transmitting antenna 110 and the receiving antenna 124, respectively. As shown in FIG. 4A, the transmitting antenna 110 has a first thickness (T1), which may range from 20 mm to 100 mm. As shown in FIG. 4B, the receiving antenna 124 has a second thickness (T2), which may range from 5 mm to 25 mm, that is less than the first thickness (T1). In one example, the first thickness (T1) is approximately 100 mm while the second thickness (T2) is approximately 10 mm. In another example, the first thickness (T1) is approximately 50 mm while the second thickness (T2) is approximately 20 mm. Various other thicknesses can be used in addition to the examples provided above. In some embodiments, the first thickness (T1) is at least 20% greater than the second thickness (T2). In some embodiments, the first thickness (T1) is between 20-1000% greater than the second thickness (T2). The thickness differences are used to achieve high coupling between the transmitting antenna 110 and the receiving antenna 124 in an asymmetrical system in which each antenna is terminated in a different port impedances (e.g., reducing the thickness of the antenna can help in reducing a port impedance of the receiving antenna 124, relative to a port impedance of the transmitting antenna 110). In some embodiments, the thickness measurements of the transmitting antenna 110 and the receiving antenna 124 include the respective ground planes, while in other embodiments the respective ground planes are omitted from the thickness measurements.

As mentioned above, a higher coupling efficiency is achieved by designing the antenna 204 on the transmitter side to have more turns (i.e., revolutions, loops) than the antenna 304 on the receiver side. Additionally, widths of the antenna 204 (e.g., D¹ and D²) are different from widths of the antenna 304 (e.g., D3 and D4) (e.g., widths D3 and D4 are greater than widths D¹ and D², respectively). Differences in widths and number of turns can be used to lower a port impedance of the receiving antenna 124. To illustrate, in one example, the transmitting antenna 110 may have a port impedance of approximately 50 ohms, while the receiving antenna 124 may have a port impedance of approximately 5 ohms (e.g., the low port impedance may be required for a specific application). The receiving antenna 124 is able to achieve the low port impedance of 5 ohms by (i) reducing the number of turns made by the antenna 304 relative to the number of turns made by the antenna 204, and (ii) increasing a width (or widths) of the antenna 304 relative to a width (or widths) of the antenna 110. Also, the receiving antenna 124 is able to achieve the low port impedance by reducing a thickness of the receiving antenna 124, relative to a thickness of the transmitting antenna 110, and offsetting the via 305, at least in some embodiments, from a center of the receiving antenna 124.

Thus, in short, in order to achieve high coupling efficiency and TX-RX port transformation, non-identical antennas (e.g., transmitting antenna 110 and receiving antenna 124) are optimized as a pair. The optimization is achieved through: (i) increasing a thickness of the transmitting antenna 110 relative to a thickness of the receiving antenna 124, as shown in FIGS. 4A and 4B, (ii) increasing a number of turns made by the antenna 204 of the transmitting antenna 110 relative to a number of turns made by the antenna 304 of the receiving antenna 124, as shown in FIGS. 2A and 3A, (iii) varying a spacing and width of antenna segments 206 of the antenna 204 of the transmitting antenna 110 relative to a spacing and width of antenna segments 306 of the antenna 304 of the receiving antenna 124, and (iv) optionally offsetting the vias feeding the antennas 204 and 304 (e.g., in radius and feed clearance), as shown in FIG. 3C. Thus, the asymmetric nature of the coupled antennas provide more degrees of freedom to optimize them for a system with different port impedances.

FIG. 6 is a block diagram 600 illustrating an interaction between the transmitting antenna 110 and the receiving antenna 124 (e.g., when the transmitting antenna 110 and the receiving antenna 124 are positioned adjacent to each other and transferring wireless power). As shown, one or more power amplifiers are connected to the transmitting antenna 110 and are configured to provide signals to the transmitting antenna 110. The transmitting antenna 110 uses the signals provided by the one or more power amplifiers to generate electromagnetic waves, which are harvested by the receiving antenna 124. As also shown, the transmitting antenna 110 and the receiving antenna 124 are separated by one or more housings 602. The one or more housings 602, in some embodiments, are distinct antenna covers for the transmitting antenna 110 and the receiving antenna 124. In addition or separately, the one or more housings 602 may be housings of an electronic device 122 (e.g., a mobile phone's housing) and/or a transmitter pad/device 102.

Wireless power harvested by the receiving antenna 124 is provided to a receiver integrated circuit 126. The receiver integrated circuit 126 is configured to convert the harvested wireless power into useable power and provide the useable power to a load 606 (e.g., a battery, power supply, etc.) of an electronic device 122. Importantly, the receiver integrated circuit 126 is designed to convert high input power to useable power (i.e. over 20 Watt) on the receiver side for a certain output voltage, such as 20 V. To accomplish this, the receiver integrated circuit 126 has low input port impedances (e.g., about 10 times lower than an ideal impedance value of 50 Ohm).

FIGS. 7A and 7B show energy transfer efficiencies of the receiving antenna 124 and transmitting antenna 110. As shown, the receiving antenna 124 and transmitting antenna 110 are able to achieve an energy transfer efficiency of 90%. Importantly, the receiving antenna 124 and transmitting antenna 110 are able to maintain an energy transfer efficiency even when misaligned (e.g., when the receiving antenna 124 and transmitting antenna 110 are offset by approximately 4 mm, an energy transfer efficiency greater than 80% is achieved). Furthermore, the receiving antenna 124 and transmitting antenna 110 are able to achieve the high energy transfer efficiency while operating at a low frequency. For example, the transmitting antenna 110 may be configured to operate at between 30 and 100 MHz (preferably 40 MHz), meaning that electromagnetic waves radiated by the antenna 204 have wavelengths between approximately 10 meters to 3 meters (preferably 7.5 meters). Nevertheless, even with these low frequencies and large wavelengths, the example near-field power transfer system of FIGS. 2A through 4B remains highly efficient.

In light of these principles, example embodiments are provided below.

In accordance with some embodiments, a near-field charging system for wirelessly charging electronic devices using electromagnetic energy having a low frequency (e.g., below 100 MHz, preferably below 60 MHZ) is provided. The near-field charging system includes a transmitting antenna (e.g., transmitting antenna 110, FIG. 2A), including a first substrate (e.g., substrate 202, FIG. 2A) and a first antenna (e.g., antenna 204, FIG. 2A), coupled to the first substrate, that follows a first meandering pattern having a first length. For example, with reference to FIG. 2A, the antenna 204 of the transmitting antenna 110 is a first spiral pattern with a first number of revolutions (e.g., ten complete revolutions).

The near-field charging system also includes a receiving antenna (e.g., receiving antenna 124, FIG. 3A), including a second substrate (e.g., substrate 302, FIG. 3A) and a second antenna (e.g., antenna 304, FIG. 3A), coupled to the second substrate, that follows a second meandering pattern having a second length. For example, with reference to FIG. 3A, the antenna 304 of the receiving antenna 124 is a second spiral pattern with a second number of revolutions, whereby the second number of revolutions is less than the first number of revolutions made by the antenna 204. In addition, the second length is less than the first length.

In some embodiments of the near-field charging system, the transmitting antenna is configured to transmit electromagnetic energy having a frequency at or below 60 MHz (e.g., between 30 MHz and 50 MHz, preferably 40 MHZ) to the receiving antenna at an efficiency above 90%, and the receiving antenna is coupled to power-conversion circuitry (e.g., receiver integrated circuit 126, FIG. 6) for converting the electromagnetic energy into usable power for charging or powering an electronic device that is coupled to the receiving antenna and the power-conversion circuitry.

In the near-field charging system, the transmitting antenna has a first port impedance and the receiving antenna has a second port impedance that is less than the first port impedance. For example, the first port impedance may be between 40 and 60 Ohms (preferably 50 Ohms), and the second port impedance may be between 1 and 20 Ohms (preferably 5 Ohms). A difference between the first port impedance and the second port impedance can be attributed to, at least in part, differences between the first meandering pattern and the second meandering pattern. For example, as mentioned above, the first meandering pattern may be longer than the second meandering pattern, and this difference in length can contribute to the port impedance difference. Other factors contributing to the port impedance difference include but are not limited to: number of revolutions made by the first and second antennas, widths of the first and second antennas, thicknesses of the first and second substrates, and locations of feed lines (e.g., via 205 and via 305).

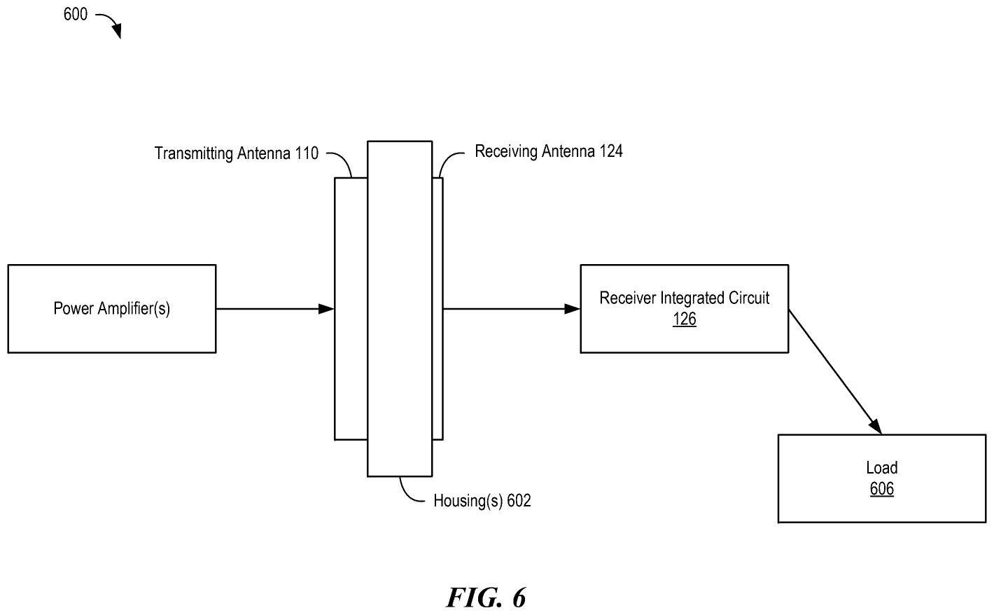

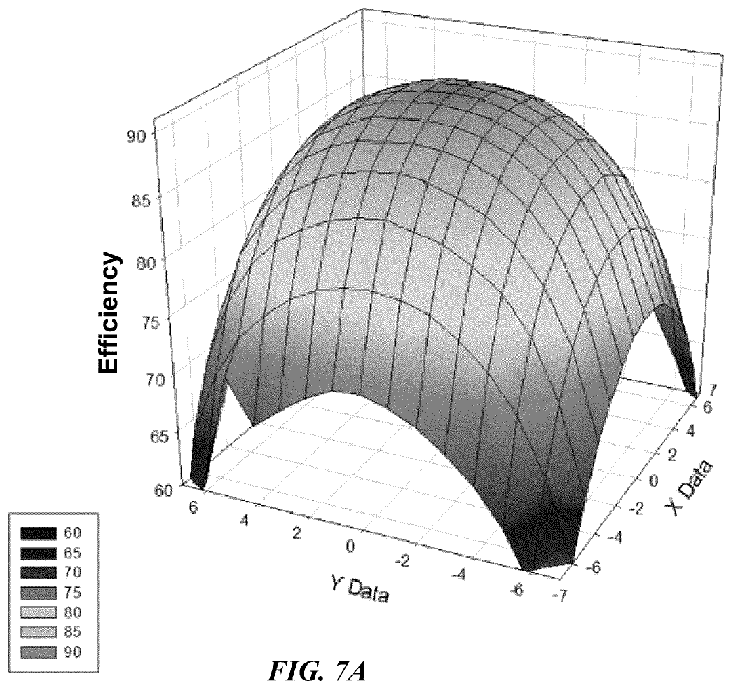

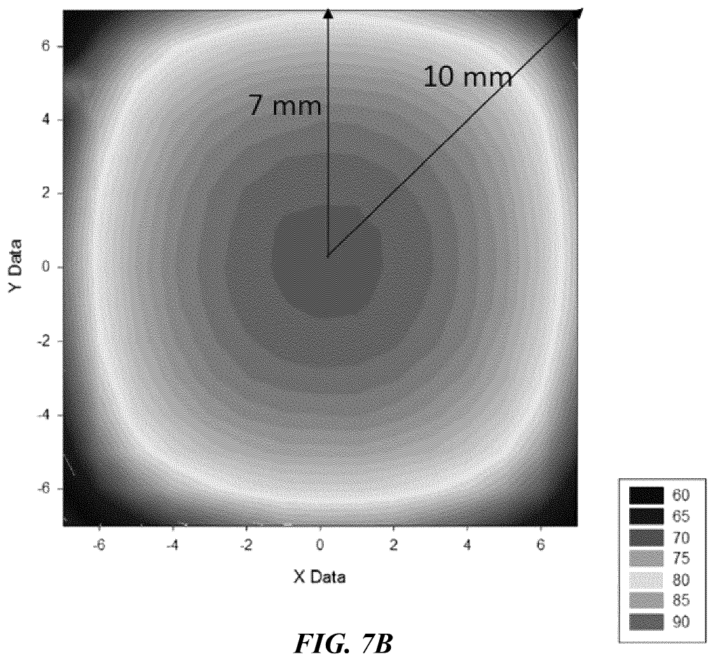

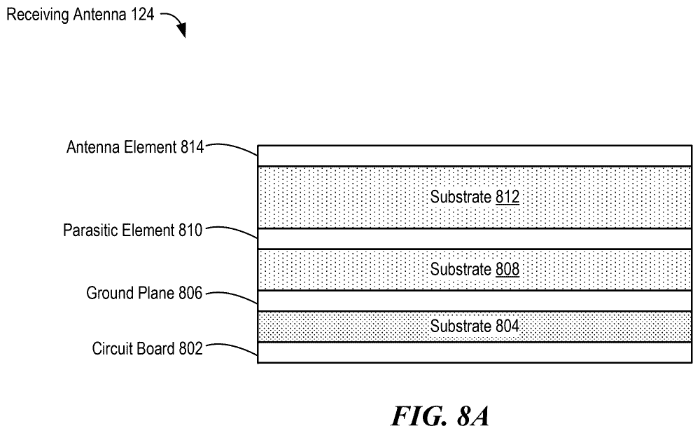

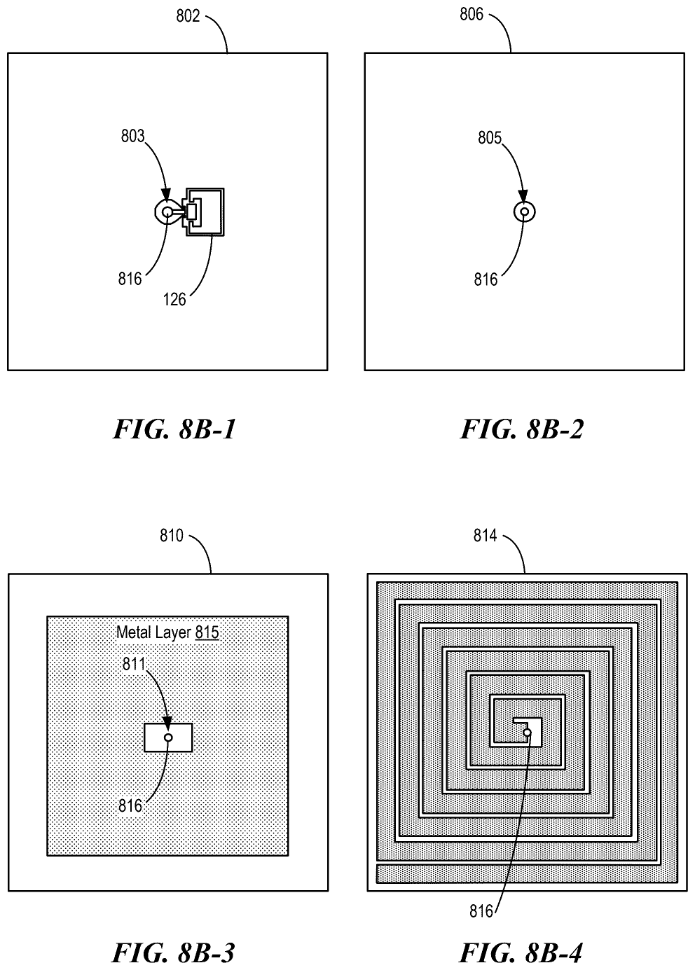

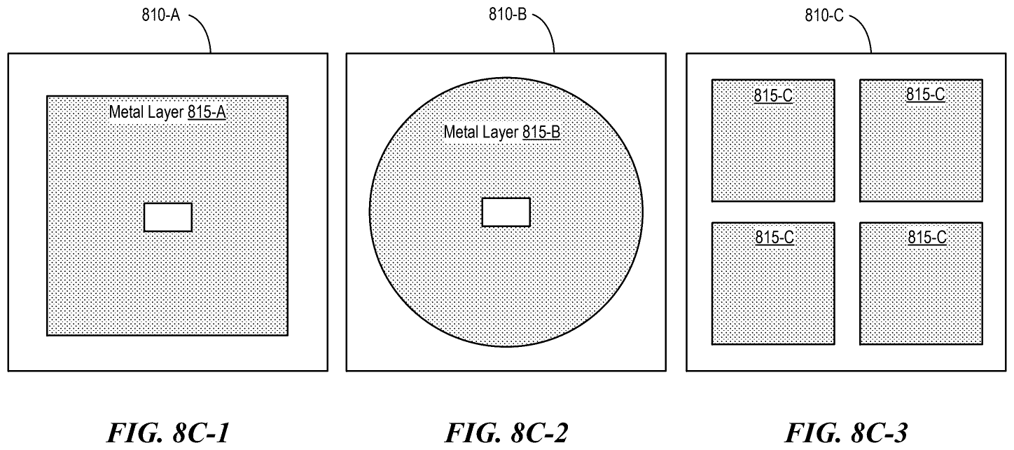

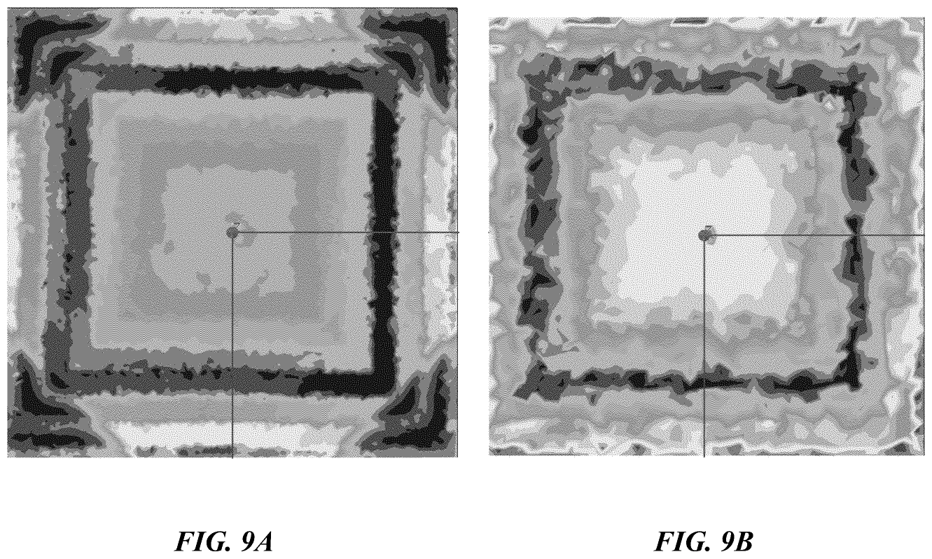

FIGS. 8A-9B are directed toward an example receiving antenna (e.g., an instance of the receiving antenna 124). In FIGS. 8A-9B, the example receiving antenna is similar to the receiving antenna discussed above with reference to FIGS. 3A-3C, but the receiving antenna addressed here also includes a parasitic element 810 that is used to make the receiving antenna less sensitive to misalignment with the transmitting antenna. In other words, incorporation of the parasitic element 810 in the receiving antenna helps to maintain a wireless power transfer efficiency within 10% of peak performance (e.g., peak performance being measured when the receiving antenna 124 and the transmitting antenna 110 are aligned center-to-center) for a defined range of movements/offset. As one example, the wireless power transfer efficiency stayed within 10% of peak performance when the receiving antenna 124 and the transmitting antenna 110 were misaligned, center-to-center, by one inch. In another example, the wireless power transfer efficiency stayed within 2% of peak performance when the receiving antenna 124 and the transmitting antenna 110 were misaligned, center-to-center, by one centimeter. Additional examples of misalignment are discussed below with reference to FIGS. 10A-10B.

FIG. 8A shows a side view of the example receiving antenna 124 having a parasitic element 810 in accordance with some embodiments. As shown, the receiving antenna 124 includes a circuit board 802, a ground plane 806, a substrate 804 separating the circuit board 802 and the ground plane 806, a parasitic element 810, a substrate 808 separating the parasitic element 810 and the ground plane 806, an antenna element 814, and another substrate 812 separating the parasitic element 810 and the antenna element 814. In some embodiments, the antenna element 814 is electrically isolated from the parasitic element 810 (e.g., by the substrate 812). The circuit board 802, ground plane 806, parasitic element 810, and antenna element 814 are discussed in further detail below. It is noted that the respective thicknesses of the components shown in FIG. 8A represent example thicknesses, and it should be understood that the thicknesses of the components could be different.

FIGS. 8B-1 to 8B-4 show the individual components of the example receiving antenna 124 in accordance with some embodiments. Starting with FIG. 8B-1, the circuit board 802 (e.g., a printed circuit board) defines a first opening 803 that is sized to receive a transmission line 816, which supplies current to the circuit board 802 from the antenna element 814. The circuit board 802 also includes one or more power converters 126, and the transmission line 816 is connected to the one or more power converters 126. In some embodiments, the circuit board 802 also includes one or more of the components shown in FIG. 1A for the receiver 120, e.g., one or more of the communications components 144, the processors 140, the memory 142, and the receiver sensors 128.

FIG. 8B-2 shows the ground plane 806 of the receiving antenna 124. The ground plane 806 is an example of the ground plane 307 discussed above with reference to FIG. 4B. The ground plane 806 may be formed by materials such as metal, alloys, and composites (e.g., ground plane 806 may be formed by copper or a copper alloy). As shown in FIG. 8B-2 (and like the circuit board 802), the ground plane 806 defines a second opening 805 that is sized to receive the transmission line 816. In some embodiments, the ground plane 806 may be electrically connected to the antenna 204. In some other embodiments, the ground plane 207 is not electrically connected to the antenna element 814. In such embodiments, the transmission line 816 is separated and insulated from the ground plane 806. The ground plane 806 may act as a reflector of electromagnetic waves radiated toward the receiving antenna 124. In other words, the ground plane 806 may not allow electromagnetic transmission beyond the ground plane 806 by cancelling and/or reflecting the electromagnetic transmission. Reflecting electromagnetic waves by the ground plane 806 may reinforce the electromagnetic waves received by the receiving antenna 124.

FIG. 8B-3 shows the parasitic element 810 of the receiving antenna 124. The parasitic element 810 may be formed by a metal layer 815, which is made from materials such as metal, alloys, and composites (e.g., the parasitic element 810 may be formed by copper or a copper alloy). As shown in FIG. 8B-3 (and like the circuit board 802 and the ground claim 806), the parasitic element 810 defines a third opening 811 that is sized to receive the transmission line 816. Notably, the parasitic element 810 is not electrically connected to the transmission line 816 (e.g., the second opening 805 electrically insulates the parasitic element 810 from the transmission line 816, and/or the transmission line 816 includes an insulating jacket). In some embodiments, the parasitic element 810 may disrupt energy field distributions around the receiving antenna 124. The degree of disruption caused by the parasitic element 810 to the energy field distributions around the receiving antenna 124 is dependent, at least in part, on a shape of the parasitic element 810. Various example shapes of the parasitic element 810 are discussed below with reference to FIGS. 8C-1 to 8C-3.

FIG. 8B-4 shows the antenna element 814. The antenna element 814 is an example of the antenna element 306, and for the sake brevity, duplicate description of the antenna element 306 is not repeated here. As shown, a central portion of the antenna element 814 is connected to the transmission line 816, such that energy harvested by the antenna element 814 is conveyed to the power converters 126 by the transmission line 816. It is noted that the transmission line 816 may be an example of the via 305, which is discussed above with reference to FIGS. 3A-3C.

FIGS. 8C-1 to 8C-3 show various examples of the parasitic element 810. With reference to FIG. 8C-1, the parasitic element 810-A is rectangular shaped with a central opening for the transmission line 816 to pass through. The rectangular shape of the parasitic element 810-A disrupts energy field distributions around the receiving antenna 124 is a first manner, which is shown in FIG. 9B. With reference to FIG. 8C-2, the parasitic element 810-B is circular shaped with a central opening for the transmission line 816 to pass through. The circular shape of the parasitic element 810-B disrupts energy field distributions around the receiving antenna 124 is a second manner distinct from the first manner. Finally, with reference to FIG. 8C-3, the parasitic element 810-C includes multiple rectangular-shaped parts separated from one another so that the transmission line 816 can pass through. The rectangular-shaped parts of the parasitic element 810-C disrupt energy field distributions around the receiving antenna 124 is a third manner distinct from the first and second manners. The benefits (and drawbacks) of disrupting the energy field distributions around the receiving antenna 124 through the use of a shaped parasitic element 810 are discussed below with reference to FIGS. 9A-9B and 10A-10B.

FIGS. 9A and 9B show example receiving antennas with and without the parasitic element 810. Starting with 9A, the receiving antenna 124 does not include the parasitic element 810. As shown, the energy field distributions around the receiving antenna 124 is well defined and consistent. The energy field distributions shown in FIG. 9A correspond to the energy field distributions created by the receiving antenna 124 shown in FIGS. 3A-3C and 4B. As discussed in relation to those figures, the receiving antenna 124 is highly efficiency, surpassing a 90% efficiency.

FIG. 9B shows energy transfer efficiencies of an example receiving antenna with the parasitic element 810. As shown, the energy field distributions around the receiving antenna 124 are less defined and consistent relative to the energy field distributions shown in FIG. 9A. The result shown in FIG. 9B is caused by the receiving antenna 124 having the parasitic element 810, which is adapted to disrupt the energy field distributions around the receiving antenna 124 (as discussed above at FIGS. 8A-8C). Consequently, while still highly efficient, the receiving antenna 124 of FIG. 9B is slightly less efficient than the receiving antenna 124 of FIG. 9A (e.g., when the transmitting and receiving antennas are aligned center-to-center).

While the receiving antenna 124 of FIG. 9B is slightly less efficient, disrupting the energy field distributions around the receiving antenna 124 is beneficial in near-field charging systems because users generally do not place the electric device on, e.g., a transmitter pad, so that the transmitting antenna 110 and the receiving antenna are perfectly aligned center-to-center. Rather, what typically occurs is that the transmitting antenna 110 and the receiving antenna 124 are misaligned to some degree (e.g., misaligned by an inch or less), and having energy field distributions around the receiving antenna 124 that are less defined (as shown in FIG. 9B) accommodates the misalignment between the transmitting antenna 110 and the receiving antenna. To repeat an example from above, a wireless power transfer efficiency stayed within 10% of peak performance when the receiving antenna 124 (which include the parasitic element 810) and the transmitting antenna 110 were misaligned, center-to-center, by one inch.

FIGS. 10A and 10B show example receiving antennas with and without the parasitic element 810. In both figures, the receiving antenna 124 is rotated relative to the transmitting antenna, which causes a misalignment between the two antennas. Starting with 10A, the receiving antenna 124 does not include the parasitic element 810 and, as indicated by the blue, green, and yellow colors in FIG. 10A, an amount of energy being transferred from the transmitting antenna 110 to the receiving antenna 124 is very low. In contrast, with reference to FIG. 10B, the receiving antenna 124 includes the parasitic element 810 and, as indicated by the red and orange colors in FIG. 10B, an amount of energy being transferred from the transmitting antenna 110 to the receiving antenna 124 is high, even though the antennas are misaligned.

Thus, in sum, while incorporating the parasitic element 810 into the receiving antenna 124 may cause a slight sacrifice in peak performance of the system (e.g., when the transmitting antenna 110 and the receiving antenna 124 are perfectly aligned center-to-center), incorporating the parasitic element 810 into the receiving antenna 124 results in the system being more versatile and user friendly as some degree of mobility is built into the system (e.g., the receiving antenna 124 can be misaligned with the transmitting antenna 110 to some degree and an efficient transfer of wireless power can still be achieved). Mobility in wireless charging systems is particularly important so that said systems can accommodate electric devices of varying sizes, as the precise location of the receiving antenna 124 is the devices will likely vary from device to device (e.g., mobile phone size varies from manufacture to manufacture and even within a given manufacture). Moreover, given that users tend to not align the target electric devices with the transmitting device perfectly (i.e., misalignment to some degree is foreseeable), the receiving device 120 and parasitic element 810 combination discussed herein provides a novel mechanism to address this foreseeable misalignment.

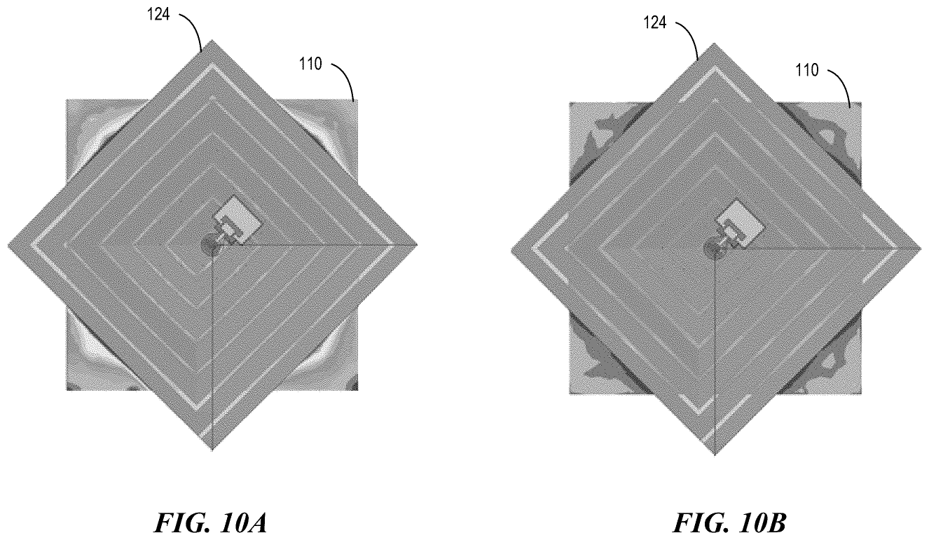

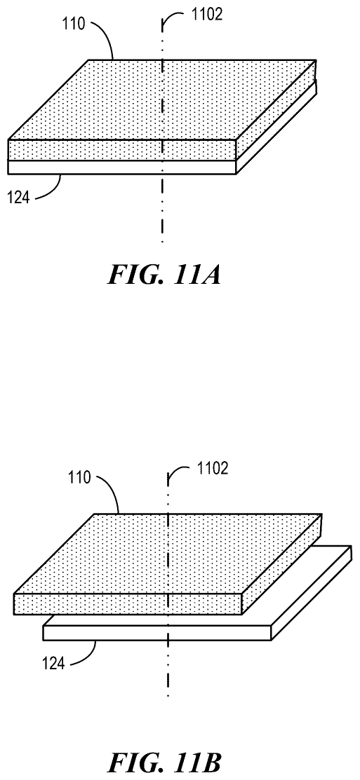

To provide some additional context into the meaning of misalignment, FIG. 11A shows the receiving antenna 124 aligned center-to-center with the transmitting antenna 110 (i.e., not misaligned), while FIG. 11B shows the receiving antenna 124 misaligned with the transmitting antenna 110. At bottom, misalignment (i.e., center-to-center misaligned between the receiving and transmitting antennas) derives from the antenna of the receiving antenna 124 being offset from (as shown in FIG. 11B) and/or rotated relative to the antenna of the transmitting antenna 110 (as shown in FIG. 10B).

All of these examples are non-limiting and any number of combinations and multi-layered structures are possible using the example structures described above.

It will be understood that, although the terms “first,” “second,” etc. are used above to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Features of the present invention can be implemented in, using, or with the assistance of a computer program product, such as a storage medium (media) or computer readable storage medium (media) having instructions stored thereon/in which can be used to program a processing system to perform any of the features presented herein. The storage medium (e.g., memory 106) can include, but is not limited to, high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. Memory (e.g., 106, 134, and/or 142) optionally includes one or more storage devices remotely located from the CPU(s) (e.g., processor(s) 104, 132, and/or 140). Memory (e.g., 106, 134, and/or 142), or alternatively the non-volatile memory device(s) within the memory, comprises a non-transitory computer readable storage medium.

Stored on any one of the machine readable medium (media), features of the present invention can be incorporated in software and/or firmware for controlling the hardware of a processing system (such as the components associated with the transmitters 102 and/or receivers 120), and for enabling a processing system to interact with other mechanisms utilizing the results of the present invention. Such software or firmware may include, but is not limited to, application code, device drivers, operating systems, and execution environments/containers.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

I/We claim:

1. A near-field charging system for wirelessly charging electronic devices using electromagnetic energy having a low frequency, the near-field charging system comprising:
a transmitting antenna comprising:
a first substrate; and
a first antenna, coupled to the first substrate, that follows a first meandering pattern having a first length, wherein the transmitting antenna has a first port impedance; and
a receiving antenna comprising:
a second substrate; and
a second antenna, coupled to the second substrate, that follows a second meandering pattern having a second length, wherein: (i) the second length is less than the first length, and (ii) the receiving antenna has a second port impedance that is less than the first port impedance,
wherein:
the receiving antenna is coupled to power-conversion circuitry for converting the electromagnetic energy into usable power for charging or powering an electronic device that is coupled to the receiving antenna and the power-conversion circuitry.

2. The near-field charging system of claim 1, wherein:
the second substrate includes opposing first and second surfaces, whereby the second antenna is coupled to the first surface; and
the receiving antenna further comprises a parasitic element, coupled to the second surface of the second substrate, adapted to disrupt energy field distributions around the receiving antenna.

3. The near-field charging system of claim 2, wherein the receiving antenna is configured to:
harvest electromagnetic energy having a low frequency at an efficiency above 90% when aligned center-to-center with the transmitting antenna, and
harvest electromagnetic energy having a low frequency at an efficiency above 85% when misaligned center-to-center with the transmitting antenna by approximately 5 mm.

4. The near-field charging system of claim 3, wherein:
the first meandering pattern is a first spiral pattern with a first number of revolutions; and
the second meandering pattern is a second spiral pattern with a second number of revolutions, the second number of revolutions being less than the first number of revolutions.

5. The near-field charging system of claim 4, wherein:
the first spiral pattern is a planar rectangular spiral; and
the second spiral pattern is a planar rectangular spiral.

6. The near-field charging system of claim 1, wherein:
the transmitting antenna further comprises a first via configured to feed radio frequency (RF) signals to the first antenna; and
the receiving antenna further comprises a second via configured to transfer energy harvested by the second antenna to the power-conversion circuitry.

7. The near-field charging system of claim 6, wherein:
the first via is positioned at a center of the first substrate; and
the second via is offset in at least one direction from a center of the second substrate.

8. The near-field charging system of claim 7, wherein:
the first substrate has a first thickness; and
the second substrate has a second thickness that is less than the first thickness.

9. The near-field charging system of claim 1, wherein:
the first antenna has a first width; and
the second antenna has a second width that is greater than the first width.

10. The near-field charging system of claim 9, wherein:
the first antenna comprises a first plurality of antenna elements; and
at least one antenna element of the first plurality of antenna elements has a third width that is less than the first width.

11. The near-field charging system of claim 10, wherein:
the second antenna comprises a second plurality of antenna elements; and
at least one antenna element of the second plurality of antenna elements has a fourth width that is less than the second width and greater than the third width.

12. The near-field charging system of claim 11, wherein the transmitting antenna is configured to transmit electromagnetic energy having a frequency between 30 MHz and 50 MHz.

13. The near-field charging system of claim 12, wherein the transmitting antenna is configured to transmit electromagnetic energy having a frequency at 40 MHz.

14. A near-field charging system for wirelessly charging electronic devices using electromagnetic energy having a low frequency, the near-field charging system comprising:
a pair of asymmetric antennas, including: (i) a transmitting antenna and (ii) a receiving antenna,
wherein:
the receiving antenna is coupled to power-conversion circuitry for converting the electromagnetic energy into usable power for charging or powering an electronic device that is coupled to the receiving antenna and the power-conversion circuitry.

15. The near-field charging system of claim 14, wherein:
an antenna of the transmitting antenna follows a first spiral pattern with a first number of revolutions; and
an antenna of the receiving antenna follows a second spiral pattern with a second number of revolutions, the second number of revolutions being less than the first number of revolutions.

16. The near-field charging system of claim 15, wherein:
the transmitting antenna includes a first via;
the receiving antenna includes a second via; and
when the transmitting antenna is aligned with the receiving antenna, the first via and the second via are axially misaligned.

17. The near-field charging system of claim 16, wherein the pair of asymmetric antennas terminate with different port impedances.

18. The near-field charging system of claim 17, wherein:
the transmitting antenna has a port impedance of approximately 50 ohms, and
the receiving antenna has a port impedance of approximately 5 ohms.

19. A receiving antenna for wirelessly charging electronic devices using electromagnetic energy having a low frequency, the receiving antenna comprising:
a parasitic element shaped to reduce the receiving antenna's sensitivity to misalignment with a corresponding transmitting antenna; and
an antenna element, positioned on top of and electrically isolated from the parasitic element, that follows a spiral pattern,
wherein the receiving antenna is configured to:
harvest electromagnetic energy having a low frequency at an efficiency above 90% when aligned center-to-center with a corresponding transmitting antenna; and
harvest electromagnetic energy having a low frequency at an efficiency above 85% when misaligned center-to-center with the corresponding transmitting antenna by approximately 5 mm.

20. The receiving antenna of claim 19, wherein the parasitic element is rectangular or circular shaped.
